(19) United States
(12) Patent Application Publication
(10) Pub. No.: US 2021/0299683 A1
(43) Pub. Date: Sep. 30, 2021

(54) MEASUREMENT APPARATUS

(71) Applicant: SYSMEX CORPORATION, Kobe-shi (JP)

(72) Inventors: Tomoya HAYASHI, Kobe-shi (JP); Shinya MURAKAMI, Kobe-shi (JP)

(73) Assignee: SYSMEX CORPORATION, Kobe-shi (JP)

(21) Appl. No.: 17/209,286

(22) Filed: Mar. 23, 2021

(30) Foreign Application Priority Data
Mar. 25, 2020 (JP) 2020-053892

(51) Int. Cl. B05B 1/34; B05B 1/06; B05B 1/30

(52) U.S. Cl. CPC B05B 1/34; B05B 1/30; B05B 1/06

(57) ABSTRACT

Disclosed is a measurement apparatus including: a first setting base capable of having set thereon a plurality of first storage portions arranged in a first direction; a second setting base capable of having set thereon a second storage portion, the second setting base being disposed in a second direction crossing the first direction with respect to the first setting base; a holding body configured to hold the first setting base and to hold the second setting base; a drive unit configured to move the holding body in the first direction; a dispenser configured to move along a movement axis thereof in the second direction, to suction a liquid in the second storage portion and dispense the liquid into each first storage portion; a measurement unit configured to measure a mixture dispensed in the first storage portion; and a movement stopping unit.

### CROSS REFERENCE TO RELATED APPLICATIONS

This application claims priority from prior Japanese Patent Application No. 2020-053892, filed on Mar. 25, 2020, entitled “MEASUREMENT APPARATUS”, the entire content of which is incorporated herein by reference.

### FIELD OF THE INVENTION

The present invention relates to a measurement apparatus including a dispenser that dispenses a liquid.

### BACKGROUND

Japanese Laid-Open Patent Publication No. 2006-300589 discloses a dispensing machine 900 as shown in FIG. 21. The dispensing machine 900 includes: a stage 902 provided so as to be movable in a Y1 direction and a Y2 direction, and including a plurality of tube receiving holes 901 each configured to have attached thereto a tube 905 into which a sample is dispensed; a dispensing head 903 which supplies a sample to tubes 905 attached to a plurality of tube receiving holes 901 disposed at a predetermined pitch in the stage 902; and a head guide mechanism 904 which holds the dispensing head 903 so as to be movable in an X1 direction and an X2 direction. The dispensing machine 900 is configured to be able to dispense a sample to an arbitrary tube 905 attached to a tube receiving hole 901, by moving the stage 902 in the Y1 direction and the Y2 direction, and by moving the dispensing head 903 in the X1 direction and the X2 direction.

### SUMMARY OF THE INVENTION

The scope of the present invention is defined solely by the appended claims, and is not affected to any degree by the statements within this summary.

In Japanese Laid-Open Patent Publication No. 2006-300589 above, with respect to the horizontal direction, the stage 902 is movable only in the Y1 direction and the Y2 direction, and the dispensing head 903 is movable only in the X1 direction and the X2 direction. Therefore, for example, when performing an operation of dispensing a reagent from a reagent container disposed in a region 912 on the stage 902 into each of the tubes 905 attached to the plurality of tube receiving holes 901 disposed in a region 911 on the stage 902, the stage 902 is moved in the Y1 direction first, and then the dispensing head 903 is moved in the X1 direction to suction a reagent from a reagent container disposed in the region 912. Then, the dispensing head 903 is moved in the X2 direction to dispense the reagent to a first tube 905 among the plurality of tubes 905 disposed in the region 911. Then, the dispensing head 903 is moved in the X1 direction to suction a reagent again from a reagent container disposed in the region 912, and the stage 902 is moved in the Y1 direction. Then, the dispensing head 903 is moved in the X2 direction to dispense the reagent into a second tube 905 among the plurality of tubes 905 disposed in the region 911. When a reagent is to be dispensed into a third tube 905 among the plurality of tubes 905, the stage 902 is moved in the Y2 direction, and then the dispensing head 903 is moved in the X1 direction to suction a reagent again from a reagent container disposed in the region 912. Then, the stage 902 is moved in the Y1 direction, and then the dispensing head 903 is moved in the X2 direction to dispense the reagent into the third tube 905 among the plurality of tubes 905 disposed in the region 911. Thus, performing an operation of dispensing a reagent from a reagent container disposed in the region 912 into each of the plurality of tubes 905 disposed in the region 911 requires a complicated operation in which the stage 902 and the dispensing head 903 are repeatedly reciprocated between the region 911 in which the plurality of tubes 905 are disposed and the region 912 in which reagent containers are disposed. When the total movement distance of the stage 902 and the dispensing head 903 is increased due to the reciprocating movement, the time required for the dispensing operation becomes longer.

As shown in FIG. 1, a measurement apparatus according to the present invention includes: a first setting base (10) capable of having set thereon a plurality of first storage portions (11) arranged in a first direction (Y1); a second setting base (20) capable of having set thereon a second storage portion (21) storing a liquid different from the liquid stored in each of the plurality of first storage portions (11); a holding body (60) configured to hold the first setting base (10) and to hold the second setting base (21) so as to be movable relative to the first setting base (10); a drive unit (50) configured to move the holding body (60) in the first direction (Y1); a dispenser (30) configured to move along a movement axis (31) thereof in a second direction (X1), to suction the liquid in the second storage portion (21) on the second setting base (20) and dispense the liquid into each first storage portion (11) on the first setting base (10); a measurement unit (40) configured to measure a mixture dispensed in the first storage portion (11) by the dispenser (30); and a movement stopping unit (25) configured to, when the holding body (60) has been moved in the first direction (Y1) by the drive unit (50), stop movement in the first direction (Y1) of the second setting base (20) while the first setting base (10) is still allowed to be moved in the first direction (Y1).

As described above, the measurement apparatus according to the present invention includes: the holding body (60) configured to hold the first setting base (10) and to hold the second setting base (21) so as to be movable relative to the first setting base (10); and the movement stopping unit (25) configured to, when the holding body (60) has been moved in the first direction (Y1) by the drive unit (50), stop movement in the first direction (Y1) of the second setting base (20) while the first setting base (10) is still allowed to be moved in the first direction (Y1). Accordingly, as shown in FIGS. 1B to 1D, by use of the holding body (60), the drive unit (50), and the movement stopping unit (25), the second storage portion (21) on the second setting base (20) is positioned at a position on the movement axis (31) at which the dispenser (30) can suction the liquid, and the first setting base (10) is moved in the first direction (Y1), whereby the plurality of first storage portions (11) set in the first direction (Y1) can be sequentially positioned at a position on the movement axis (31) at which the dispenser (30) can discharge the liquid. That is, since the second setting base (20) is movable relative to the holding body (60), a state where the liquid can be suctioned from the second storage portion (21) is established even in a case where the first setting base (10) is fixed to the holding body (60). Thus, dispensing operation can be performed, without the drive unit (50) causing each setting base to perform reciprocating operation in the first direction (Y1 direction) and the direction (Y2 direction) opposite thereto, but by the drive unit (50) causing each setting base to move only in one direction, i.e., in the first direction (Y1 direction). As a result, even when the liquid stored in the second storage portion (21) is dispensed into each of the plurality of first storage portions (11), the number of times of reciprocating operation required for the dispensing can be reduced. Since the number of times of reciprocating operation is reduced, the total movement distance of each setting base can be reduced. Therefore, the time required in the dispensing operation can be shortened.

### BRIEF DESCRIPTION OF THE DRAWINGS

FIG. 1A is a schematic diagram showing an outline of a measurement apparatus;

FIG. 1B shows how a first setting base and a second setting base are moved;

FIG. 1C shows how the first setting base and the second setting base are moved;

FIG. 1D shows how the first setting base and the second setting base are moved;

FIG. 2 is a schematic diagram showing a first example of the first setting base and a first storage portion;

FIG. 3 is a schematic diagram showing a second example of the first setting base and the first storage portion;

FIG. 4A is a schematic diagram showing a modification of the first setting base and the second setting base;

FIG. 4B is a schematic diagram showing a modification of a movement stopping unit;

FIG. 5 is a schematic plan view showing a specific configuration example of the measurement apparatus;

FIG. 6 is a diagram for describing a configuration example of a dispenser;

FIG. 7 is a plan view showing a configuration example of the first setting base and the second setting base;

FIG. 8 shows a state where the second setting base is in contact with a stopper;

FIG. 9 is a top view for describing a structure of a holding body;

FIG. 10 shows a configuration example of a drive unit;

FIG. 11 shows a configuration example of a measurement unit;

FIG. 12 is a block diagram showing a configuration related to control processes of the measurement apparatus and a control apparatus;

FIG. 13 shows an example of a screen showing setting positions of first storage portions;

FIG. 14 is a diagram for describing a method for obtaining setting positions for first storage portions as measurement targets;

FIG. 15 is a first diagram for describing an example of operation of the measurement apparatus;

FIG. 16 is a second diagram for describing an example of operation of the measurement apparatus;

FIG. 17 is a third diagram for describing an example of operation of the measurement apparatus;

FIG. 18 is a fourth diagram for describing an example of operation of the measurement apparatus;

FIG. 19 is a flowchart for describing processing operation of the control apparatus;

FIG. 20 is a flowchart for describing measurement operation of the measurement apparatus; and

FIG. 21 is a diagram for describing conventional art.

### DETAILED DESCRIPTION OF THE PREFERRED EMBODIMENTS

Hereinafter, an embodiment will be described with reference to the drawings.

[Outline of Measurement Apparatus]

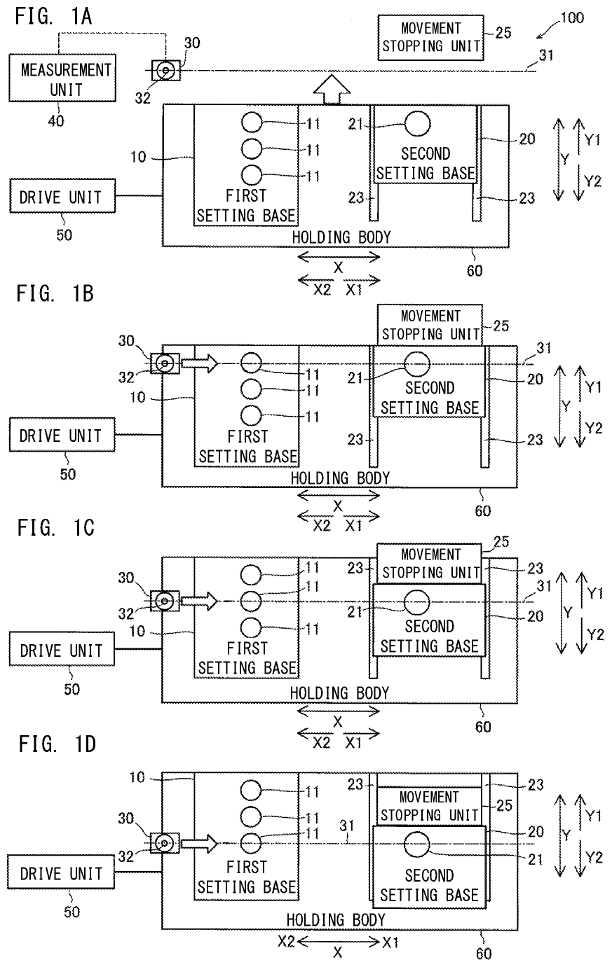

First, with reference to FIG. 1, the outline of a measurement apparatus 100 according to an embodiment is described.

The measurement apparatus 100 is an apparatus which measures a measurement sample created by adding a predetermined reagent to a specimen collected from a subject.

The subject is mainly a human, but may be an animal other than human. The measurement apparatus 100 performs measurement for a clinical test or a medical study of a specimen collected from a patient, for example. The specimen is a specimen derived from an organism. The specimen derived from an organism is, for example, blood (whole blood, serum, or plasma), urine, a liquid such as another body fluid each of which has been collected from the subject, a liquid obtained by subjecting a collected liquid to a predetermined pretreatment, or the like. The specimen may be, for example, a part of a tissue or cells of the subject, or the like, other than a liquid. The measurement apparatus 100 detects a predetermined analyte contained in the specimen. The analyte can include, for example, a predetermined component, a cell, or a particle in blood or a urine specimen. The analyte may be a nucleic acid such as DNA (deoxyribonucleic acid), a specific cell, an intracellular substance, an antigen, an antibody, a protein, a peptide, or the like. The measurement apparatus 100 may be a blood cell counter, a cell image analyzer, a blood coagulation measurement apparatus, an immunoassay apparatus, a urine particle measurement apparatus, or the like, or may be a measurement apparatus other than these.

As shown in FIG. 1A, the measurement apparatus 100 includes a first setting base 10, a second setting base 20, a holding body 60, a drive unit 50, a dispenser 30, a measurement unit 40, and a movement stopping unit 25.

The first setting base 10 is configured such that a plurality of first storage portions 11 which each store a liquid can be set thereon in a first direction Y1. The first setting base 10 is configured such that one or a plurality of specimen containers can be set thereon.

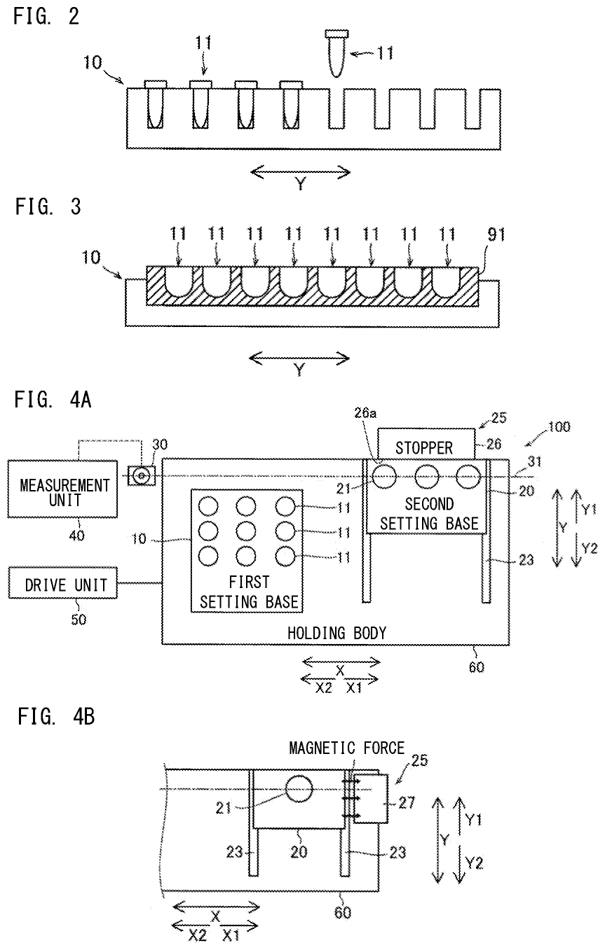

Each first storage portion 11 is a recess capable of storing a liquid therein. The first storage portion 11 has an open top, an inner bottom face, and an inner side face. The open top serves as an inlet/outlet for a liquid. The first storage portion 11 can retain a predetermined amount of liquid. The first storage portion 11 can be an inner space of a liquid container. At least one first storage portion 11 is provided for one liquid container. A liquid container (hereinafter, referred to as a “single container”) having one first storage portion 11 formed therein is, for example, a test tube, a specimen container, a cuvette, a sample tube, a liquid bottle, or the like, as shown in FIG. 2. In this case, the first storage portion 11 is the liquid container itself. A liquid container (hereinafter, referred to as a “multi-container”) having a plurality of first storage portions 11 formed therein is, for example, a microplate as shown in FIG. 3. In this case, the first storage portions 11 are individual wells formed in the liquid container.

The first setting base 10 can have set thereon a plurality of first storage portions 11 as the single containers, shown in FIG. 2, for example. The first setting base 10 is configured to be able to hold a plurality of first storage portions 11, which are single containers, arranged in the first direction Y1. The first setting base 10 can have set thereon one or a plurality of multi-containers 91, shown in FIG. 3, having a plurality of first storage portions 11, for example. The first setting base 10 is configured to be able to have set thereon a plurality of first storage portions 11 in the first direction Y1, by holding the multi-container 91 in an orientation in which the plurality of first storage portions 11 formed in the multi-container 91 are arranged in the first direction Y1.

The first setting base 10 has a plate-like shape, for example. In the first setting base 10, the upper face serves as a setting face for the first storage portions 11. The first setting base 10 supports a plurality of single containers or one or more multi-containers from below. The first setting base 10 can include, on the upper face, an insertion hole for inserting one first storage portion 11, or a recess for setting one multi-container 91. The first setting base 10 may indirectly support each first storage portion 11 via a member for holding the first storage portion 11. The member for holding the liquid container may be, for example, a rack capable of holding a plurality of single containers, a holder having a plurality of holding holes formed therein, or the like.

The second setting base 20 shown in FIG. 1A can have set thereon a second storage portion 21 storing a liquid different from liquids stored in a plurality of first storage portions 11.

The second storage portion 21 is a recess capable of storing a liquid therein. The second storage portion 21 has an open top, an inner bottom face, and an inner side face. The open top serves as an inlet/outlet for a liquid. The second storage portion 21 can retain a predetermined amount of liquid. At least one second storage portion 21 is provided for one liquid container. The second storage portion 21 can be a single container. The second storage portion 21 can be an individual well formed in the multi-container. The second setting base 20 can have set thereon at least one second storage portion 21. That is, the second setting base 20 may be able to have only one single container set thereon. Different from the first setting base 10, when a plurality of second storage portions 21 are set on the second setting base 20, the plurality of second storage portions 21 are set so as to be arranged in a second direction X1.

The second setting base 20 has a flat-plate shape or a rectangular parallelepiped shape, for example. In the second setting base 20, the upper face serves as a setting face for the second storage portion 21. The second setting base 20 supports, from below, a single container or a multi-container having the second storage portion 21 formed therein. The second setting base 20 can include, on the upper face, an insertion hole for inserting one second storage portion 21, or a recess for setting one multi-container.

The second setting base 20 is disposed, with respect to the first setting base 10, in the second direction X1 which crosses the first direction Y1. In addition, as described later, the second setting base 20 is configured to be movable relative to the first setting base 10 in a direction Y2 opposite to the first direction Y1.

The second direction X1 is one direction in a horizontal plane, and crosses the first direction Y1. In FIG. 1A, the second direction X1 is a direction orthogonal to the first direction Y1 in the horizontal plane. That is, the first direction Y1 and the second direction X1 mean two directions that are orthogonal to each other in the horizontal plane. In this specification, “being orthogonal” includes not only a case of crossing at an angle of strict 90 degrees but also a case of crossing at an angle that can be regarded as being substantially orthogonal, and may be an angle slightly deviated from a right angle due to an assembly error, for example. Hereinafter, the first direction Y1 may be referred to as a Y1 direction. The second direction X1 may be referred to as an X1 direction. The first direction Y1 and the direction Y2 opposite thereto are collectively referred to as a Y direction, and the second direction X1 and a direction X2 opposite thereto are collectively referred to as an X direction.

The second setting base 20 is disposed at a position shifted in the second direction X1 with respect to the first setting base 10. In FIG. 1A, the first setting base 10 and the second setting base 20 are linearly arranged along the second direction X1.

The holding body 60 holds the first setting base 10 and the second setting base 20. The holding body 60 holds the first setting base 10 in a fixed manner, and holds the second setting base 20 so as to allow relative movement thereof in the direction Y2 opposite to the first direction Y1.

“Holding the first setting base 10 in a fixed manner” means that, when the holding body 60 is moved by the drive unit 50 described later, the first setting base 10 does not move with respect to the holding body 60. Therefore, the first setting base 10 need not be fixed to or integrated with the holding body 60. The holding body 60 detachably holds the first setting base 10. The holding body 60 may have an engagement portion that engages with the first setting base 10. The holding body 60 has a recess into which a lower portion of the first setting base 10 is fitted, for example.

Meanwhile, when moved by the drive unit 50, the holding body 60 holds the second setting base 20 in a state where the second setting base 20 is movable relative to the first setting base 10. That is, the holding body 60 holds the second setting base 20 in a state of being movable on the holding body 60. The holding body 60 may include a guide portion which guides movement of the second setting base 20 in the first direction Y1 and in the opposite direction Y2. The guide portion may include, for example, a rail, a groove, and a guide member that support the second setting base 20 so as to be able to slide in the first direction Y1 and the opposite direction Y2. The holding body 60 supports the second setting base 20 so as not to be able to move in the second direction X1 and the opposite direction X2, for example.

The drive unit 50 is configured to move the holding body 60. The drive unit 50 moves the holding body 60 holding the first setting base 10 and the second setting base 20, in the first direction Y1 toward a movement axis 31 of the dispenser 30. Hereinafter, with reference to the initial position shown in FIG. 1A, with respect to the Y axis, the Y1 direction is the direction from the first setting base 10 toward the movement axis 31 of the dispenser 30, and the Y2 direction is the direction away from the movement axis 31 of the dispenser 30. The drive unit 50 can move the holding body 60 in the Y1 direction and the Y2 direction.

The drive unit 50 includes an actuator for generating a driving force for moving the holding body 60. The actuator can include an electric (electromagnetic) actuator such as an electric motor, a linear motor, or a solenoid, a pressure actuator such as a pneumatic cylinder or a hydraulic cylinder, or the like. The drive unit 50 may include a linear motion mechanism for causing the holding body 60 to linearly move in the first direction Y1 and the opposite direction Y2. The drive unit 50 moves the holding body 60, thereby integrally moving both of the first setting base 10 and the second setting base 20 held by the holding body 60.

The movement stopping unit 25 is configured to stop, when the holding body 60 has been moved in the first direction Y1 by the drive unit 50, movement in the first direction Y1 of the second setting base 20 while the first setting base 10 is still allowed to move further in the first direction Y1, in a state where a first storage portion 11 and a second storage portion 21 are disposed on the movement axis 31 of the dispenser 30. Accordingly, with a simple configuration in which the second setting base 20 held by the holding body 60 is contacted, engaged, or fixed by the movement stopping unit 25, the second storage portion 21 on the second setting base 20 can be stopped at a position on the movement axis 31 at which liquid suction by the dispenser 30 is allowed, even when the first setting base 10 is moved in the first direction Y1.

The movement stopping unit 25 is disposed at a predetermined position in the first direction Y1 with respect to the second setting base 20. The movement stopping unit 25 is provided on the movement path of the second setting base 20. The movement stopping unit 25 is provided so as to come into contact with the second setting base 20 which moves together with the holding body 60 moved by the drive unit 50.

The movement stopping unit 25 is fixed to a housing or the like of the measurement apparatus 100. Accordingly, the movement stopping unit 25 stops movement of the second setting base 20. The movement stopping unit 25 is provided so as not to come into contact with the holding body 60 and the first setting base 10 (i.e., the portion that moves integrally with the first setting base 10). Accordingly, even in a state where the movement stopping unit 25 is in contact with the second setting base 20, the first setting base 10 can be moved further in the first direction Y1.

The dispenser 30 is configured to move along the movement axis 31 in the second direction X1 and the opposite direction X2. The dispenser 30 is configured to move along the movement axis 31, to suction a liquid in a second storage portion 21 on the second setting base 20 and dispense the liquid into a first storage portion 11 on the first setting base 10.

The dispenser 30 is configured to be able to suction and discharge a liquid. The dispenser 30 has one or more nozzles 32 that each suction and discharge a liquid. In FIG. 1A, one nozzle 32 is provided. However, for example, the dispenser 30 may include a plurality of nozzles 32 in the second direction X1. The nozzle 32 is a tubular member that linearly extends, for example. The dispenser 30 is disposed at a position above the first storage portions 11 set on the first setting base 10 and the second storage portion 21 set on the second setting base 20. The dispenser 30 can move the nozzle 32 in an up-down direction, for example. An upper end portion of the nozzle 32 is connected to a pump. The dispenser 30 can suction a liquid from the tip (i.e., lower end) of the nozzle 32 due to a negative pressure from the pump, and can discharge the liquid from the tip of the nozzle 32 due to a positive pressure from the pump.

In FIG. 1A, the movement axis 31 linearly extends in the second direction X1 and the opposite direction X2. The dispenser 30 performs reciprocating movement due to a linear motion mechanism, in the second direction X1 and the opposite direction X2, for example. Strictly speaking, the movement axis 31 is a movement path of the tip of the nozzle 32 in a horizontal plane. The dispenser 30 can dispose the tip of the nozzle 32 at an arbitrary position on the movement axis 31. The dispenser 30 can suction a liquid and discharge the liquid at an arbitrary position on the movement axis 31.

In a state where measurement is not started yet, the dispenser 30 is disposed at a position away from the first setting base 10 and the second setting base 20 in the first direction Y1. In the example in FIG. 1, in a horizontal plane, the dispenser 30 cannot move in the first direction Y1 and can move in the second direction X1 and the opposite direction X2. The drive unit 50 moves the first setting base 10 and the second setting base 20 in the first direction Y1 to positions on the movement axis 31 of the dispenser 30.

The dispenser 30 moves the nozzle 32 downwardly from a position immediately above the second storage portion 21, thereby being able to suction the liquid stored in the second storage portion 21 into the nozzle 32. The dispenser 30 moves the nozzle 32 downwardly from a position immediately above a first storage portion 11, thereby being able to discharge the suctioned liquid into the first storage portion 11 from the tip of the nozzle 32. Accordingly, the dispenser 30 forms, in the first storage portion 11, a mixture of the liquid stored in the second storage portion 21 and the liquid stored in the first storage portion 11.

As an example, the first storage portion 11 stores a first liquid containing a specimen. The first liquid is a pretreated sample obtained through pretreatment on a specimen, for example. The second storage portion 21 stores a second liquid, which is a reagent. The reagent is a liquid to be used in measurement of an analyte. The reagent can contain a substance that reacts with a substance contained in the first liquid. The reagent may not necessarily react with a substance contained in the first liquid. The reagent may contain, in a state of being mixed with a sample, a substance measured separately from the analyte. A measurement result of such a substance can be used in calibration in measurement of the analyte, or operation control of the measurement apparatus 100, for example.

The measurement unit 40 is configured to measure a mixture dispensed in the first storage portion 11 by the dispenser 30. For example, the measurement unit 40 is in fluid connection with the dispenser 30, and obtains a mixture from the dispenser 30 having suctioned the mixture. The measurement unit 40 is set on the movement axis 31, for example, and the mixture is dispensed by the dispenser 30 having moved to a position immediately above the measurement unit 40.

The measurement unit 40 can be configured to measure the mixture and detect an analyte contained in the mixture. The method for detecting the analyte by the measurement unit 40 may be any method. The measurement unit 40 detects the analyte using a method suitable for the analyte, such as a chemical method, an optical method, an electromagnetics method, or the like. On the basis of the result of the detection by the measurement unit 40, the presence or absence of the analyte, the number or amount of the analyte, the concentration of the analyte, the presence ratio between the analyte and a substance other than the analyte, and the like are analyzed, for example.

Operation of the measurement apparatus 100 shown in FIG. 1 is described. In the measurement apparatus 100 of the present embodiment, as shown in FIG. 1A, in a state where a plurality of first storage portions 11 are set on the first setting base 10, and a second storage portion 21 is set on the second setting base 20, measurement operation is started. First, the drive unit 50 moves the holding body 60 toward the dispenser 30 in the first direction Y1. The plurality of first storage portions 11 are defined as, from the head of the dispenser 30 side (Y1 direction side) in order, the first storage portions 11 at the first, the second, and the third orders, respectively.

As shown in FIG. 1B, the drive unit 50 moves the first storage portion 11 at the first order on the first setting base 10, and the second storage portion 21 on the second setting base 20, onto the movement axis 31 of the dispenser 30. By moving along the movement axis 31, the dispenser 30 suctions the second liquid in the second storage portion 21 and discharges the second liquid into the first storage portion 11 at the first order. The mixture of the first liquid and the second liquid formed in the first storage portion 11 at the first order by the dispenser 30 is measured by the measurement unit 40.

Next, as shown in FIG. 1C, the drive unit 50 moves the holding body 60 in the first direction Y1 to dispose the first storage portion 11 at the second order onto the movement axis 31. At this time, the second storage portion 21 set on the second setting base 20 is stopped at a position on the movement axis 31. That is, the first setting base 10 and the holding body 60 move in the Y1 direction, whereas the second setting base 20 moves in the Y2 direction relative to the holding body 60, such that the second setting base 20 remains at the position on the movement axis 31. Accordingly, the first setting base 10 advances to the Y1 direction side, compared with the second setting base 20. By moving along the movement axis 31, the dispenser 30 suctions the second liquid in the second storage portion 21 and discharges the second liquid into the first storage portion 11 at the second order. A mixture formed in the first storage portion 11 at the second order by the dispenser 30 is measured by the measurement unit 40.

Next, as shown in FIG. 1D, the drive unit 50 moves the first setting base 10 in the first direction Y1 to dispose the first storage portion 11 at the third order onto the movement axis 31. The second setting base 20 remains stopped at the position on the movement axis 31, and the first setting base 10 advances to the further Y1 direction side, compared with the second setting base 20. By moving along the movement axis 31, the dispenser 30 suctions the second liquid in the second storage portion 21 and discharges the second liquid into the first storage portion 11 at the third order. A mixture formed in the first storage portion 11 at the third order by the dispenser 30 is measured by the measurement unit 40.

In this manner, the measurement operation in the measurement apparatus 100 is performed.

The measurement apparatus 100 of the present embodiment includes: the holding body 60 which holds the first setting base 10 in a fixed manner and holds the second setting base 20 so as to allow relative movement thereof in the first direction Y1 and the opposite direction Y2; and the drive unit 50 which moves the holding body 60 holding the first setting base 10 and the second setting base 20, in the first direction Y1 toward the movement axis 31 of the dispenser 30. Accordingly, as shown in FIG. 1B to FIG. 1D, by the holding body 60 and the drive unit 50, the second storage portion 21 on the second setting base 20 can be positioned on the movement axis 31 at which a liquid can be suctioned by the dispenser 30, and the first setting base 10 can be moved in the first direction Y1 such that the plurality of first storage portions 11 set in the first direction Y1 can be sequentially positioned at a position on the movement axis 31 at which the liquid can be discharged by the dispenser 30. That is, since the second setting base 20 is movable with respect to the holding body 60, even when the first setting base 10 is fixed to the holding body 60, a state where a liquid can be suctioned from the second storage portion 21 is established. Thus, dispensing operation can be performed, without the drive unit 50 causing each setting base to perform reciprocating operation in the first direction Y1 and the opposite direction Y2, but by the drive unit 50 causing each setting base to move only in one direction, i.e., in the first direction Y1. As a result, even when the liquid stored in the second storage portion 21 is dispensed into each of the plurality of first storage portions 11, the number of times of reciprocating operation required in the dispensing can be reduced. Since the number of times of reciprocating operation is reduced, the total movement distance of each setting base can be reduced. Therefore, the time required in the dispensing operation can be shortened.

<Position of Second Setting Base>

Preferably, the second setting base 20 is configured such that, in a state where the first storage portion 11 at the head in the first direction Y1 is disposed on the movement axis 31 of the dispenser 30, the second storage portion 21 is also disposed on the movement axis 31 of the dispenser 30. That is, preferably, as shown in FIG. 1, the second storage portion 21 on the second setting base 20 is disposed on the movement axis 31 simultaneously with the first storage portion 11 at the head, or in advance of the first storage portion 11 at the head. Accordingly, without movement of the holding body 60 in the Y2 direction, dispensing into all of the first storage portions 11 can be realized in a state where the second storage portion 21 is disposed on the movement axis 31. Thus, as shown in FIG. 4, the second setting base 20 may be disposed at a position on the first direction Y1 side, with respect to the first setting base 10. In this case, the second storage portion 21 is disposed on the movement axis 31 in advance of the first storage portion 11 at the head in the first direction Y1, and then, each first storage portion 11 on the first setting base 10 is positioned onto the movement axis 31.

In FIG. 1, the first setting base 10 and the second setting base 20 are separated from each other in the second direction X1. However, the second setting base 20 may be adjacent to the first setting base 10 in the second direction X1.

<The Number and Position of First Storage Portion and Second Storage Portion>

In the example in FIG. 4, the first setting base 10 not only can have set thereon a plurality of first storage portions 11 arranged in the first direction Y1, but can also have set thereon a plurality of first storage portions 11 arranged in the second direction X1. The example in FIG. 4 shows an array of first storage portions 11 in 3 rows×3 columns. In this case, dispensing and measurement can be performed from the first storage portions 11 in the head row in the Y1 direction in order, in a unit of row.

Similarly, in the example in FIG. 4, the second setting base 20 can have set thereon a plurality of second storage portions 21. In FIG. 4, the second setting base 20 can have set thereon a plurality of second storage portions 21 arranged in the second direction X1. The plurality of second storage portions 21 may store a liquid of the same kind, or may store liquids of different kinds. The kind of the liquid here means the composition of the liquid. Meanwhile, for example, the second setting base 20 may be able to have set thereon a plurality of second storage portions 21 arranged in the first direction Y1. When the second setting base 20 moves relative to the holding body 60 in the first direction Y1 and the opposite direction Y2, an arbitrary second storage portion 21 in the first direction Y1 can be disposed on the movement axis 31.

<Stopper>

FIG. 4A shows an example of the movement stopping unit 25 which holds, at a predetermined position in the first direction Y1, the second setting base 20 held by the holding body 60. In FIG. 4A, the measurement apparatus 100 further includes a stopper 26 as the movement stopping unit 25. The stopper 26 stops, by contacting the second setting base 20 in a state where the first storage portions 11 and the second storage portions 21 are disposed on the movement axis 31 of the dispenser 30, movement in the first direction Y1 of the second setting base 20 while the first setting base 10 is still allowed to move further in the first direction Y1. Accordingly, with a simple configuration in which the second setting base 20 held by the holding body 60 is contacted by the stopper 26, each second storage portion 21 on the second setting base 20 can be stopped at the position on the movement axis 31 at which liquid suction by the dispenser 30 is allowed, even when the first setting base 10 is moved in the first direction Y1.

The stopper 26 is disposed at a predetermined position in the first direction Y1 with respect to the second setting base 20. The stopper 26 is provided on the movement path of the second setting base 20. The stopper 26 is provided so as to come into contact with the second setting base 20 moving together with the holding body 60 moved by the drive unit 50.

The stopper 26 has a contact face 26a that comes into contact with the second setting base 20. The structure of the stopper 26 is not limited in particular, as long as the stopper 26 has the contact face 26a. The stopper 26 can be a plate-like member or a block-like member, for example. The stopper 26 is fixed to the housing or the like of the measurement apparatus 100. Accordingly, the stopper 26 stops movement of the second setting base 20. The stopper 26 is provided so as not to come into contact with the holding body 60 and the first setting base 10 (i.e., the portion that moves integrally with the first setting base 10). Accordingly, even in a state where the stopper 26 is in contact with the second setting base 20, the first setting base 10 can be moved further in the first direction Y1.

The second setting base 20 is moved integrally with the first setting base 10 in the first direction Y1 from the initial position up to the position at which the second setting base 20 contacts the stopper 26. The first setting base 10 is moved in the first direction Y1 from the initial position up to a position on the first direction Y1 side with respect to the stopper 26, beyond the position where the stopper 26 is disposed. As a result, while the second storage portion 21 on the second setting base 20 remains held at the position on the movement axis 31 of the dispenser 30, a plurality of first storage portions 11 on the first setting base 10 are sequentially positioned at the position on the movement axis 31.

For the movement stopping unit 25 which holds, at a predetermined position in the first direction Y1, the second setting base 20 held by the holding body 60, a technique that causes the second setting base 20 to move relative to the holding body 60 by causing electric or magnetic force to act, can be adopted, other than the stopper 26. An example of a matter that causes magnetic force to act is a magnetic member 27 such as a magnet. As shown in FIG. 4B, the magnetic member 27 of the movement stopping unit 25 stops movement in the first direction Y1 of the second setting base 20, by causing magnetic force to act on the second setting base 20 in a state where the second storage portion 21 is disposed on the movement axis 31 of the dispenser 30, for example.

[Specific Configuration Example of Measurement Apparatus]

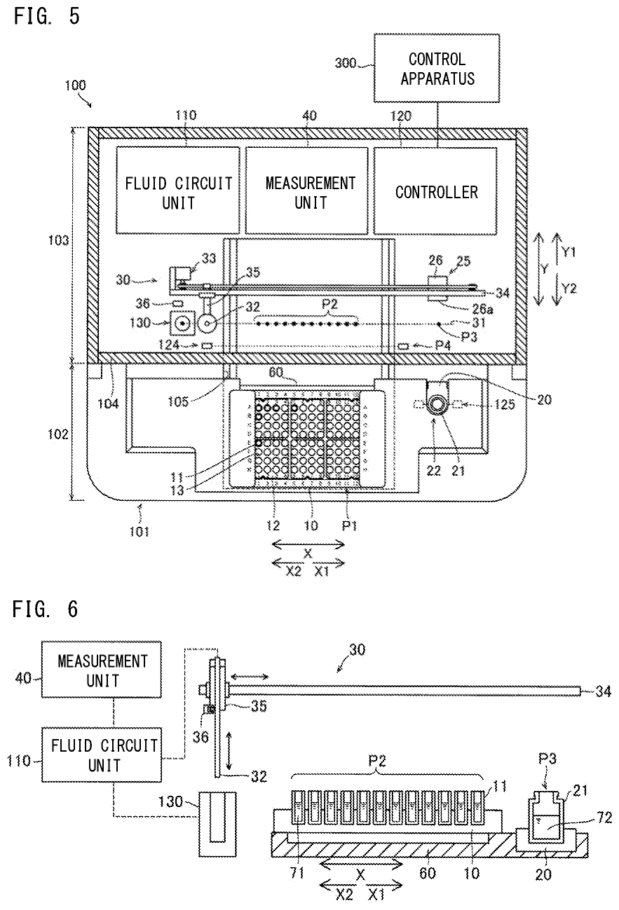

Next, with reference to FIG. 5 to FIG. 18, a specific configuration example of the measurement apparatus 100 is described in detail. In the example shown in FIG. 5 to FIG. 18, the analyte targeted by the measurement apparatus 100 is a specific gene. The measurement apparatus 100 is an apparatus that measures, through flow cytometry, cells of which a gene is labeled with a labeling substance such as a fluorescent substance or an enzyme, and that analyzes, on the basis of the measurement result, whether or not the labeled gene is included in cells.

More specifically, the measurement apparatus 100 measures a sample prepared in pretreatment including a step of hybridizing a nucleic acid probe labeled with a fluorescent dye and a target site in a nucleic acid, thereby detecting, on the basis of a FISH method, a cell having an abnormality at the target site as an abnormal cell. The pretreatment includes, for example: a step of collecting nucleated cells as measurement target cells from a blood specimen collected from a subject; a step of labeling a target site in each cell with a fluorescent dye; and a step of staining the nucleus of each cell with a nucleus staining dye. The pretreatment includes, for example: a process of fixing cells so as to prevent the cells from contracting due to dehydration; a membrane permeation process of making, in the cells, holes having a size that allows introduction of a probe into the cells; a thermal denaturation process of applying heat to the cells; a process of hybridizing the target site and the probe; a washing process of removing unnecessary probes from the cells; and a process of staining the nuclei.

In the FISH method, the target site on the chromosome is detected by using one or more fluorescent dyes. Preferably, in the FISH method, a first target site and a second target site are detected by using two or more fluorescent dyes. The first target site is hybridized with a probe labeled with a first fluorescent dye that generates a first fluorescence having a wavelength λ21, by being irradiated with a light having a wavelength λ11. The second target site is hybridized with a probe labeled with a second fluorescent dye that generates a second fluorescence having a wavelength λ22, by being irradiated with a light having a wavelength λ12. The nucleus is stained by a nucleus staining dye that generates a third fluorescence having a wavelength λ23, by being irradiated with a light having a wavelength λ13. The lights having the wavelength λ11, the wavelength λ12, and the wavelength λ13 are so-called excitation light. A pretreated sample is stored as the first liquid in the first storage portion 11.

As shown in FIG. 5, the measurement apparatus 100 includes the first setting base 10, the second setting base 20, the dispenser 30, the drive unit 50, the holding body 60, and the stopper 26. The measurement apparatus 100 includes the measurement unit 40, a fluid circuit unit 110, and a controller 120. The dispenser 30, the measurement unit 40, the drive unit 50, the holding body 60, the stopper 26, the fluid circuit unit 110, and the controller 120 are housed in a housing 101. The measurement apparatus 100 is communicably connected to a control apparatus 300. FIG. 5 shows an example in which the control apparatus 300 is provided separately from the measurement apparatus 100. However, the control apparatus 300 may be built in the measurement apparatus 100. In this case, the control apparatus 300 and the controller 120 may be integrated together.

The housing 101 includes a container setting part 102 and a body part 103.

The container setting part 102 is a part on the Y2 direction side of the housing 101, and has a table-like flat upper face portion. The container setting part 102 is provided with a setting work position P1 for the first storage portion 11 and the second storage portion 21. At the setting work position P1 of the container setting part 102, the first setting base 10 and the second setting base 20 can be exposed to the outside of the housing 101.

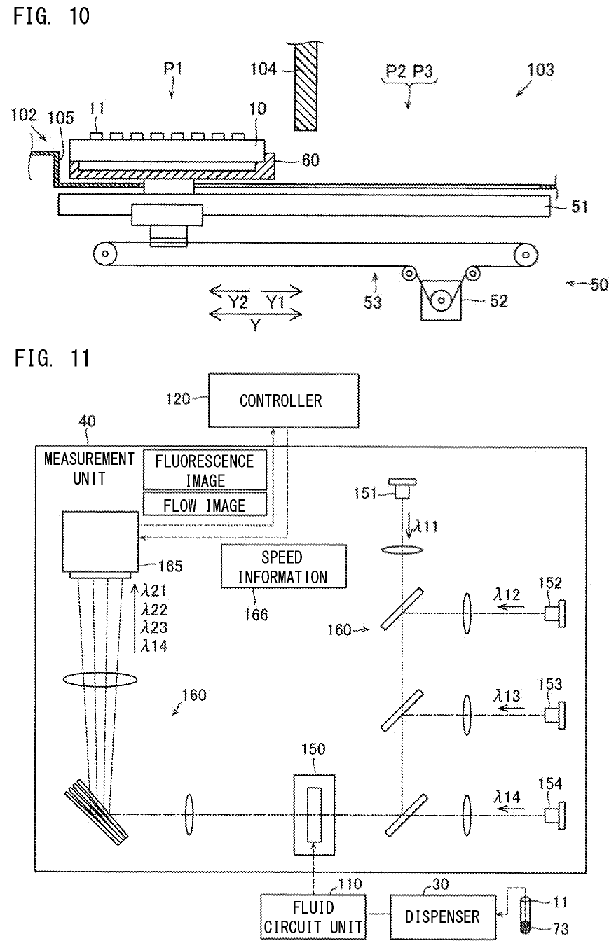

The body part 103 is a part on the Y1 direction side of the housing 101, and has a box-like shape in which an inner space separated from the outside is formed. The body part 103 houses, in the inner space, the dispenser 30, the measurement unit 40, the fluid circuit unit 110, and the controller 120. The drive unit 50 (see FIG. 10) moves the first setting base 10 and the second setting base 20 held by the holding body 60, in the first direction Y1 and the opposite direction Y2 across the container setting part 102 and the body part 103.

The measurement apparatus 100 includes a separation wall 104 which provides separation between the setting work position P1 and the dispenser 30. The separation wall 104 is provided so as to provide partition that passes at least a position between the setting work position P1 and the dispenser 30. In the example in FIG. 5, the separation wall 104 is a part of the housing 101 and provides partition between the container setting part 102 and the body part 103.

The holding body 60 is configured to be movable in a reciprocating manner in the Y1 direction and the Y2 direction between the setting work position P1 and the movement axis 31 of the dispenser 30. The first setting base 10 and the second setting base 20 are provided so as to pass below (see FIG. 10) the separation wall 104. Accordingly, the space for the setting work position P1 at which a user performs a setting work of the first storage portion 11 and the second storage portion 21 and the space in which the dispenser 30 operates can be partitioned by the separation wall 104. Therefore, the user can be inhibited from erroneously contacting the dispenser 30 at the time of setting work of the first storage portion 11 and the second storage portion 21.

The holding body 60 is disposed in a recess 105 formed in the upper face of the table-like container setting part 102. The first setting base 10 is set on the upper face of the holding body 60. A plurality of first storage portions 11 can be set on the upper face of the first setting base 10. One second storage portion 21 can be set on the upper face of the second setting base 20.

The holding body 60 is provided so as to be linearly movable in the first direction Y1 and the opposite direction Y2. The holding body 60 is provided so as not to be able to move except in the first direction Y1 and the opposite direction Y2. The first setting base 10 and the second setting base 20 held by the holding body 60 are integrally moved in the first direction Y1 by the drive unit 50 (see FIG. 10) up to a position at which the second setting base 20 contacts the stopper 26. In a state where the second setting base 20 and the stopper 26 are in contact with each other, the holding body 60 and the first setting base 10 can be moved further in the first direction Y1 while movement in the first direction Y1 of the second setting base 20 is stopped. Detailed configurations of the holding body 60, the first setting base 10, and the second setting base 20 are described later.

The dispenser 30 is set in the body part 103, and is movable in a reciprocating manner in the second direction X1 and the opposite direction X2 along the movement axis 31 in the second direction X1. The dispenser 30 includes: the nozzle 32; a nozzle drive unit 33 and a linear motion mechanism 34 for moving the nozzle 32; a raising/lowering mechanism 35; and an origin sensor 36.

As shown in FIG. 5 and FIG. 6, the nozzle 32 is implemented as a suction tube extending in the up-down direction. The nozzle 32 is connected to the fluid circuit unit 110 via a flow path. The fluid circuit unit 110 supplies the nozzle 32 with a negative pressure for suctioning and a positive pressure for discharging. The nozzle 32 is held at a position above the first setting base 10 and the second setting base 20. The nozzle drive unit 33 is an electric motor, for example. The linear motion mechanism 34 supports, via the raising/lowering mechanism 35, the nozzle 32 so as to be movable in the second direction X1 and the opposite direction X2. The nozzle drive unit 33 moves the nozzle 32 along the linear motion mechanism 34 via a transmission mechanism such as a belt-pulley mechanism, for example. The raising/lowering mechanism 35 is configured to be able to move the nozzle 32 in the up-down direction. The raising/lowering mechanism 35 includes an electric motor and a linear motion mechanism. Accordingly, the nozzle 32 is linearly moved in the second direction X1 and the opposite direction X2 by the nozzle drive unit 33, and is moved in the up-down direction by the raising/lowering mechanism 35 at the time of suctioning and discharging. Accordingly, the dispenser 30 suctions a second liquid 72 in the second storage portion 21 on the second setting base 20 and dispenses the second liquid 72 into a first storage portion 11 on the first setting base 10. As a result of the dispensing, a first liquid 71 and the second liquid 72 are mixed in the first storage portion 11.

The origin sensor 36 is set at one end portion of the movement axis 31, and detects the origin position in the horizontal direction of the nozzle 32.

In FIG. 5, the measurement apparatus 100 includes a washing port 130 provided at a position on the movement axis 31 of the dispenser 30 and for washing the dispenser 30. Accordingly, by simply moving in the second direction X1 and the opposite direction X2 along the movement axis 31, the dispenser 30 can perform suctioning of the liquid from the second storage portion 21, dispensing of the liquid into a first storage portion 11, and washing at the washing port 130. As a result, in a horizontal plane, the dispenser 30 only needs to be able to move in the second direction X1 and the opposite direction X2, and there is no need to provide a mechanism that moves the dispenser 30 in the first direction Y1 and the opposite direction Y2. Thus, the structure and operation of the dispenser 30 can be simplified.

The washing port 130 (see FIG. 6) is a washing chamber that has an open top and that can retain a liquid. By the washing port 130 receiving the tip side of the nozzle 32 inside, a washing process can be performed on the nozzle 32 with use of a washing liquid in the washing port 130. The washing port 130 is disposed immediately below the origin position. Therefore, every time the washing process of the nozzle 32 is performed, the nozzle position in the movement axis 31 can be returned to the origin.

The dispenser 30 can move the nozzle 32 to a plurality of discharge positions P2 and one suction position P3 on the movement axis 31, other than the origin position. The plurality of discharge positions P2 are positions at which a liquid is discharged into individual first storage portions 11 set on the first setting base 10. The suction position P3 is a position at which a liquid is suctioned from the second storage portion 21 set on the second setting base 20.

With reference to FIG. 5, the measurement unit 40 includes a flow cytometer. The measurement unit 40 is configured to apply a measurement light to a sample flowing in a flow cell, and detect scattered light and fluorescence generated due to the measurement light.

The fluid circuit unit 110 includes a chamber, a flow path, a valve, a pump, and the like. The fluid circuit unit 110 is in fluid connection with the nozzle 32 of the dispenser 30, and is in fluid connection with the flow cell of the measurement unit 40. The fluid circuit unit 110 is in fluid connection with the washing port 130. The fluid circuit unit 110 includes: a dispensing pump for dispensing a liquid by the nozzle 32; a liquid sending pump for sending a liquid suctioned from the nozzle 32 to the flow cell; a sheath liquid pump for supplying a sheath liquid to the flow cell; a sheath liquid retaining chamber; and the like. The dispensing pump, the liquid sending pump, and the sheath liquid pump are syringe pumps, for example.

The controller 120 includes a processor such as a CPU, an FPGA, or the like. The controller 120 performs operation control of each component of the drive unit 50, the dispenser 30, the fluid circuit unit 110, and the measurement unit 40.

<Holding Body, First Setting Base, Second Setting Base, and Drive Unit>

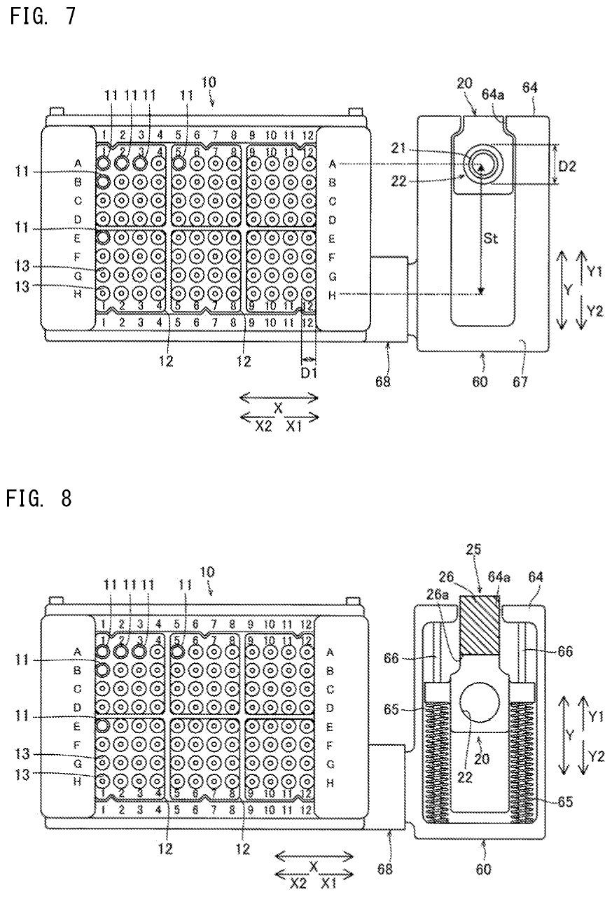

In the configuration example in FIG. 7, the first setting base 10 has a rectangular flat plate-like shape in a plan view. The first setting base 10 is configured to be able to have disposed thereon a plurality of first storage portions 11 arranged in the first direction Y1 and the opposite direction Y2, and in the second direction X1 and the opposite direction X2. Accordingly, a greater number of first storage portions 11 can be set on the first setting base 10, to be subjected to the dispensing processing performed by the dispenser 30. Even when a large number of first storage portions 11 are set on the first setting base 10, a plurality of first storage portions 11 arranged in the second direction X1 can be collectively disposed at positions (see FIG. 5) on the movement axis 31 of the dispenser 30 due to movement in the first direction Y1 of the first setting base 10. Thus, operations of the holding body 60 are not complicated.

The first storage portion 11 is a tubular sample container capable of storing a specimen, and corresponds to the single container described above. The first storage portion 11 is a PCR tube, for example.

In the configuration example in FIG. 7, the first setting base 10 includes a plurality of first holding holes 13 capable of respectively holding, one by one, a plurality of first storage portions 11. Accordingly, a first storage portion 11, as a unit, can be set to a plurality of first holding holes 13 of the first setting base 10. Since it is only necessary to set a necessary number of first storage portions 11 in accordance with the number of first storage portions 11 that are to be subjected to measurement, usability for the user is improved.

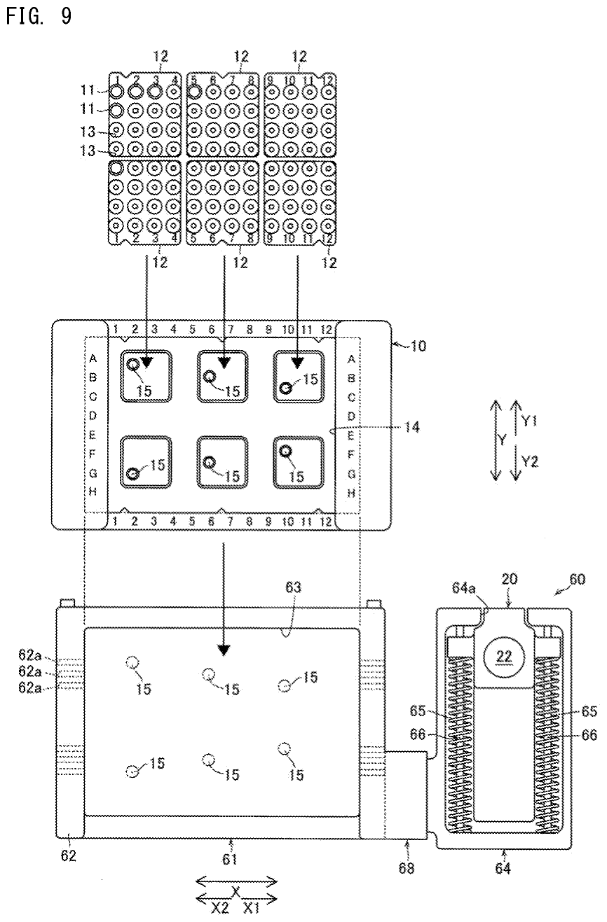

Specifically, as shown in FIG. 9, the first setting base 10 includes a container holder 12 in which first holding holes 13 for holding first storage portions 11 are formed. The container holder 12 has a plurality of first holding holes 13 and can hold a plurality of first storage portions 11. First storage portions 11 are inserted, one by one, in the first holding holes 13 of the container holder 12. The first setting base 10 has, on the upper face thereof, a recess 14 that allows the container holder 12 to be set therein. The container holder 12 is set in the recess 14. Thus, the first setting base 10 can have set thereon a plurality of first storage portions 11 via the container holder 12. Instead of providing the container holder 12, the first holding holes 13 may be formed in the first setting base 10 and the first setting base 10 may directly hold the first storage portions 11.

In the configuration example in FIG. 9, 16 first holding holes 13 are formed in one container holder 12. The first holding holes 13 are arrayed in a matrix shape of 4 rows×4 columns. The second direction X1 matches the row direction, and the first direction Y1 matches the column direction. The first setting base 10 can have set thereon a plurality of container holders 12 arranged in the recess 14. In the configuration example in FIG. 9, six container holders 12 are set in the recess 14. The first setting base 10 can have set thereon two container holders 12 arranged in the first direction Y1 and three container holders 12 arranged in the second direction X1, i.e., in a matrix shape of 2 rows×3 columns. Therefore, when six container holders 12 are arranged, a total of 96 first holding holes 13, i.e., 8 rows from Row A to Row H and 12 columns from column 1 to column 12, are disposed in a matrix shape. Instead of six container holders 12, a microplate having 96 wells may be set in the recess 14 of the first setting base 10.

A detection piece 15 for detecting the presence or absence of a container holder 12 is provided to the inner bottom face of the recess 14. One detection piece 15 is provided to the setting position of each of the six container holders 12. The detection piece 15 is a rod protruding upward from the inner bottom face of the recess 14. When a container holder 12 is set from above, the detection piece 15 is moved so as to protrude to the lower side (i.e., the holding body 60 side) of the first setting base 10. The detection piece 15 protruding to the lower side blocks the optical axis of a holder sensor 124 shown in FIG. 5, whereby the presence of the container holder 12 corresponding to the detection piece 15 is detected. The positions in the first direction Y1 of the six detection pieces 15 are different from each other. Thus, on the basis of the position in the first setting base 10 when the optical axis of the holder sensor 124 is blocked, the six detection pieces 15 can be individually identified.

The second setting base 20 is arranged with an interval in the second direction X1 from the first setting base 10. The second setting base 20 has a substantially square shape in a plan view. In the configuration example in FIG. 7, the second storage portion 21 is a tubular reagent container capable of storing a liquid and corresponds to the single container described above. As described later, in an example, the second storage portion 21 is a tubular reagent container capable of storing beads. The second setting base 20 is held in a later-described frame-shaped portion 64 of the holding body 60, and can move within the frame-shaped portion 64 in the first direction Y1 and the opposite direction Y2.

As shown in FIG. 7 and FIG. 9, the second setting base 20 includes one second holding hole 22 capable of holding one second storage portion 21. Accordingly, a liquid reagent to be dispensed into a plurality of first storage portions 11 can be collectively stored in one second storage portion 21. Therefore, when compared with a case where a plurality of second storage portions 21 are set, moving and suctioning operations of the dispenser 30 can be simplified.

An inner diameter D2 (see FIG. 7) of the second holding hole 22 is greater than an inner diameter D1 of the first holding hole 13. That is, a second storage portion 21 of a larger size and a larger volume than the first storage portion 11 can be set on the second setting base 20. Accordingly, a second storage portion 21 of a larger volume than individual first storage portions 11 can be set. Therefore, even when the second liquid in the second storage portion 21 is dispensed into a large number of first storage portions 11, the frequency of replacing the second storage portion 21 can be suppressed.

In the example in FIG. 7, the reagent is dispensed from one second storage portion 21 into a maximum of 96 first storage portions 11. Therefore, a reagent container of a bottle type and of a larger size than the first storage portion 11 is set as the second storage portion 21.

The holding body 60 is configured to hold the second setting base 20 so as to allow relative movement thereof in the first direction Y1 and the opposite direction Y2, and is configured to move integrally with the first setting base 10. As shown in FIG. 9, the holding body 60 includes a placement portion 61 formed so as to support the first setting base 10 from below. The placement portion 61 includes a recess 63 partitioned by a peripheral wall portion 62. A lower portion of the first setting base 10 is engaged (see FIG. 6) with the recess 63, whereby the first setting base 10 is fixed to the holding body 60. The first setting base 10 is attachable to/detachable from the holding body 60. The user can take out the first setting base 10 from the holding body 60, perform setting work of first storage portions 11 and container holders 12 on a work table or the like, and then, set the first setting base 10 to the holding body 60 at the setting work position P1.

A plurality of through-holes 62a penetrating the peripheral wall portion 62 in the second direction X1 and the opposite direction X2 are formed in the peripheral wall portion 62. The plurality of through-holes 62a are provided so as to correspond to the positions of the six detection pieces 15 when protruding, and the optical axis of the holder sensor 124 shown in FIG. 5 passes the through-holes 62a.

The holding body 60 includes the frame-shaped portion 64 surrounding the second setting base 20, and holds the second setting base 20 on the inner side of the frame-shaped portion 64 such that the second setting base 20 is movable in the first direction Y1 and the opposite direction Y2. The second setting base 20 is provided so as to be movable, on the inner side of the frame-shaped portion 64, in the first direction Y1 and the opposite direction Y2 relative to the frame-shaped portion 64, within a range St (see FIG. 7) between the first storage portions 11 at the head in the first direction Y1 and the first storage portions 11 at the end in the first direction Y1 on the first setting base 10. The first storage portions 11 at the head are the first storage portions 11 set in the first holding holes 13 of the first row (Row A). The first storage portions 11 at the end are the first storage portions 11 set in the first holding holes 13 of the eighth row (Row H).

Accordingly, the range St in which the second setting base 20 can move in the first direction Y1 can be assuredly restricted. Therefore, when the second setting base 20 moves in the holding body 60 due to contact with the stopper 26, it is possible to inhibit the second setting base 20 from unintentionally falling off from the holding body 60 or from being unintentionally shifted in position along the second direction X1.

The frame-shaped portion 64 has a rectangular outer shape extending in the first direction Y1. The frame-shaped portion 64 has a length corresponding to the range St. As shown in FIG. 8, a path 64a for allowing passage of the stopper 26 from the outside of the frame-shaped portion 64 to the inside thereof is formed in an end portion on the first direction Y1 side of the frame-shaped portion 64. In the example in FIG. 8, the path 64a is a cut-out portion formed in the frame-shaped portion 64.

The holding body 60 includes a biasing member 65 which biases the second setting base 20 in the first direction Y1 toward the movement axis 31 of the dispenser 30. The biasing member 65 is disposed, on the inner periphery side of the frame-shaped portion 64, on the side (Y2 direction side) opposite to the movement axis 31 of the dispenser 30 with respect to the second setting base 20. By being positioned, by the biasing member 65, to an end portion in the first direction Y1 in the movement range in the holding body 60 thereby contacting the stopper 26, the second setting base 20 moves to the opposite side (Y2 direction side) relative to the holding body 60 which moves in the first direction Y1 while compressing the biasing member 65.

Thus, the position of the second setting base 20 in a state of not contacting the stopper 26 can be fixed to an end portion on the dispenser 30 side in the holding body 60. Therefore, when the drive unit 50 moves the first setting base 10 and the second setting base 20 in the first direction Y1 from the setting work position P1 toward the movement axis 31 of the dispenser 30, it is not necessary for the user to move the second setting base 20 in advance to the position of the end portion on the dispenser 30 side in the holding body 60. Thus, convenience for the user can be improved.

In addition to the biasing member 65, a guide 66 extending in the first direction Y1 is disposed on the inner periphery side of the frame-shaped portion 64. The guide 66 guides linear movement of the second setting base 20. In the configuration example in FIG. 9, one guide 66 is disposed at each of positions on both sides in the second direction X1 and the opposite direction X2 with respect to the second setting base 20. The guides 66 are each a linear guide rod and are respectively inserted, one by one, in two insertion holes formed in the second setting base 20. The second setting base 20 linearly moves along the two guides 66 inserted in the insertion holes. In the configuration example in FIG. 8, the biasing member 65 is a compression coil spring. The guide 66 is inserted in the inner periphery side of the biasing member 65. One biasing member 65 is provided to each of the two guides 66. An end portion on the first direction Y1 side of each biasing member 65 is in contact with the second setting base 20, and an end portion on the Y2 direction side of the biasing member 65 is supported by the inner peripheral face of the frame-shaped portion 64.

The numbers of the guide 66 and the biasing member 65 may each be one. The guide 66 may be a guide groove engaged by the second setting base 20, or a guide rail that engages with a groove of the second setting base 20. The biasing member 65 may be a tension spring that biases the second setting base 20 to the movement axis 31 side (Y1 direction side) of the dispenser 30.

In FIG. 7, the upper face of the frame-shaped portion 64 is covered by a cover 67. FIG. 8 and FIG. 9 each show a state where the cover 67 has been removed. The placement portion 61 on which the first setting base 10 is placed and the frame-shaped portion 64 holding the second setting base 20 are fixed to each other by a connection portion 68. Accordingly, the holding body 60 including the placement portion 61 and the frame-shaped portion 64 is moved by the drive unit 50.

The stopper 26 is disposed below (see FIG. 5) the movement axis 31 of the dispenser 30. The stopper 26 is provided so as not to come into contact with the first setting base 10 and the holding body 60, but to come into contact with the second setting base 20. The stopper 26 is disposed at a position on a straight line in the first direction Y1 with respect to the second setting base 20. As shown in FIG. 8, the stopper 26 has, in the X direction, a width smaller than the width of the path 64a of the frame-shaped portion 64. Therefore, in a state where the stopper 26 is in contact with the second setting base 20, when the first setting base 10 and the holding body 60 are moved further in the first direction Y1, the stopper 26 passes the inner side of the path 64a without coming into contact with the holding body 60. If the stopper 26 is disposed above the holding body 60 and the contact position between the stopper 26 and the second setting base 20 is set above the holding body 60, the path 64a may not necessarily be formed.

As shown in FIG. 5, the stopper 26 is provided at a position at which the stopper 26 contacts the second setting base 20 in a state where the first storage portions 11 at the head (Row A) in the first direction Y1 among the plurality of first storage portions 11 and the second storage portion 21 are disposed on the movement axis 31 of the dispenser 30.

Accordingly, when a liquid is dispensed into the first storage portions 11 at the head (Row A), the second storage portion 21 is in a state of being stopped at the position on the movement axis 31 at which liquid suction can be performed. In addition, when all of the first storage portions 11 at the second order (Row B) and thereafter are moved in the first direction Y1 to positions on the movement axis 31, the second storage portion 21 can be caused to remain stopped at the position on the movement axis 31 at which liquid suction can be performed. Therefore, dispensing operation to all of the first storage portions 11 can be performed only through one-direction movement in the first direction Y1. Thus, operation of each setting base at the time of dispensing can be simplified as much as possible, and the total movement distance can be shortened.

As shown in FIG. 10, the drive unit 50 is provided below the holding body 60. The drive unit 50 is configured to support the holding body 60 from below and to move the holding body 60 in the first direction Y1. In the configuration example in FIG. 10, the drive unit 50 includes: a linear motion mechanism 51 in the first direction Y1 including a linear rail and a slider; an electric motor 52; and a transmission mechanism 53. The holding body 60 is supported by the linear motion mechanism 51 so as to be movable in the first direction Y1, and is coupled to the electric motor 52 via the transmission mechanism 53. In the example in FIG. 10, the transmission mechanism 53 is a belt-pulley mechanism, but may be a rack-pinion mechanism, a screw-feed mechanism, or the like. Accordingly, the drive unit 50 moves the first setting base 10 and the second setting base 20 (see FIG. 7) in association with each other via the holding body 60, in the first direction Y1 and the opposite direction Y2.

(Measurement Unit)

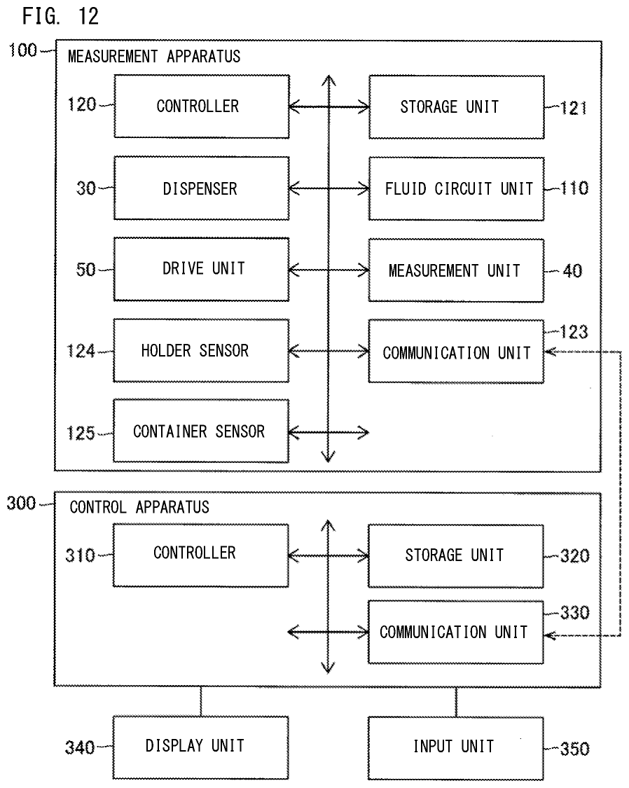

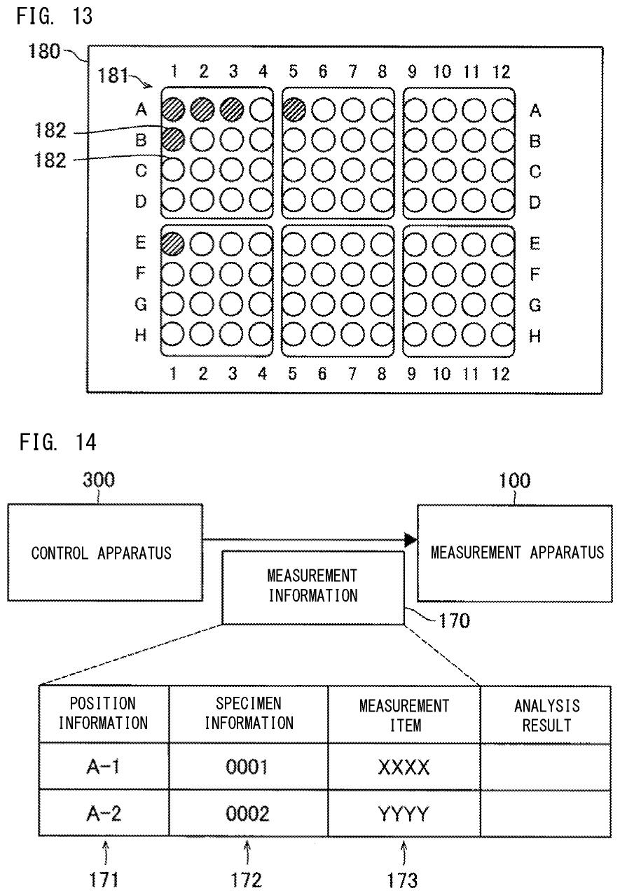

Next, a configuration example of the measurement unit 40 is described with reference to FIG. 11. In FIG. 11, the measurement unit 40 includes an imaging flow cytometer. That is, the measurement unit 40 includes an imaging section 165 which detects scattered light and fluorescence, and is configured to obtain a fluorescence image of each cell. The imaging section 165 detects fluorescence indicating the presence of an analyte.

The measurement unit 40 includes a flow cell 150, light sources 151 to 154, a light guiding section 160, and the imaging section 165. The measurement unit 40 applies light to a measurement sample 73 including a plurality of kinds of target sites labeled with fluorescences, and detects a plurality of kinds of fluorescences having different wavelengths. The measurement sample 73 is a mixture of the first liquid 71 (see FIG. 6) stored in a first storage portion 11 and the second liquid 72 (see FIG. 6) stored in the second storage portion 21. The second liquid 72 stored in the second storage portion 21 is a liquid reagent containing beads (particles) for detecting the moving speed of the sample in the flow cell 150.

The measurement unit 40 is configured to measure a particle in the specimen contained in the mixture, on the basis of a measurement result of each bead contained in the mixture. Accordingly, measurement of a particle in the specimen can be optimized or corrected by using measurement results of the beads which have less variation than an organism substance in the specimen. Thus, the particle that is the analyte can be accurately measured.

A measurement sample 73 sent from the dispenser 30 is caused to flow in the flow path of the flow cell 150 by the fluid circuit unit 110. In FIG. 10, the measurement sample 73 flows toward a direction perpendicular to the sheet of the drawing.

The light sources 151 to 154 each apply a light to the measurement sample 73 flowing in the flow cell 150. The light sources 151 to 154 are each implemented as a semiconductor laser light source. The lights emitted from the light sources 151 to 154 are laser lights having different wavelengths λ11 to λ14, respectively.

The light guiding section 160 includes condenser lenses, dichroic mirrors, and a spectroscopic optical unit. The light guiding section 160 guides, through a combination of condenser lenses and dichroic mirrors, lights emitted from the light sources 151 to 154, to the flow path of the flow cell 150. Then, lights having the wavelengths λ11 to λ14 are applied to the measurement sample 73 flowing in the flow path of the flow cell 150, in a direction orthogonal thereto.

When lights having the wavelengths λ11 to λ13 are applied to the measurement sample 73 flowing in the flow cell 150, fluorescence is generated from the fluorescent dye staining each cell. When a light having the wavelength λ11 is applied to a first fluorescent dye staining a first target site, a first fluorescence having a wavelength λ21 is generated from the first fluorescent dye. When a light having the wavelength λ12 is applied to a second fluorescent dye staining a second target site, a second fluorescence having the wavelength λ22 is generated from the second fluorescent dye. When a light having the wavelength λ13 is applied to a third fluorescent dye staining a nucleus, a third fluorescence having the wavelength λ23 is generated from the third fluorescent dye. Images of the fluorescences having the wavelengths λ21 to λ23 are respectively captured, whereby fluorescence images regarding the nucleus and two genes as the target sites can be obtained.

When a light having the wavelength λ14 is applied to the measurement sample 73 flowing in the flow cell 150, a scattered light is generated from each bead contained in the mixture flowing in the flow cell 150. An image of the scattered light of the light having the wavelength λ14 is captured by the imaging section 165, whereby a scattered light image of the bead is obtained. Each bead has a size about 1/10 of the average diameter of cells, for example, and can be easily and accurately identified on the basis of the difference in size. Other than these, the measurement unit 40 may be further provided with a light source that enables a bright field image to be captured.

In the light guiding section 160, the fluorescences having the wavelengths λ21 to λ23 generated from the measurement sample 73 and the scattered light scattered by each bead are condensed by a condenser lens. In the light guiding section 160, the fluorescences having the wavelengths λ21 to λ23 and the scattered light having the wavelength λ14 are reflected at angles slightly different from each other by using the spectroscopic optical unit, and are separated, through a condenser lens, on the light receiving surface of the imaging section 165.

The imaging section 165 is implemented as a TDI (Time Delay Integration) camera. The TDI camera includes a plurality of rows of line sensors. In the TDI camera, electric charges accumulated in the line sensors are sequentially transferred, and the electric charges are integrated, whereby high sensitivity imaging is performed. The imaging section 165 captures images of the fluorescences having the wavelengths λ21 to λ23 and the scattered light having the wavelength λ14, and generates fluorescence images respectively corresponding to the fluorescences having the wavelengths λ21 to λ23, and a flow image of each bead. Under control of the controller 120, the imaging section 165 integrates the received signals of fluorescences to generate a fluorescence image. Through the integration, the quality of the fluorescence image of the cell is enhanced. The fluorescence image is obtained for each individual cell separated while flowing in the flow cell 150. The controller 120 transmits the fluorescence image generated by the imaging section 165 to the control apparatus 300 (see FIG. 11).

Here, the controller 120 is configured to perform processing of controlling the measurement operation of the measurement unit 40 on the basis of the measurement result of the reagent stored in the second storage portion 21. The controller 120 obtains the moving speed of the bead from the flow image by the imaging section 165, to generate speed information 166 of the speed in the flow cell 150. The controller 120 outputs the speed information 166 to the imaging section 165, thereby performing a feed-back control of the electric charge transfer speed in the TDI camera. Accordingly, electric charge transfer is performed at a speed accurately matched with the actual moving speed of the cell in the captured field of view, and thus, a non-blurred high-definition continuous image (moving image) can be obtained. As a result, in the fluorescence image, a bright point due to the label contained in the cell can be accurately detected.

<Controller and Control Apparatus>

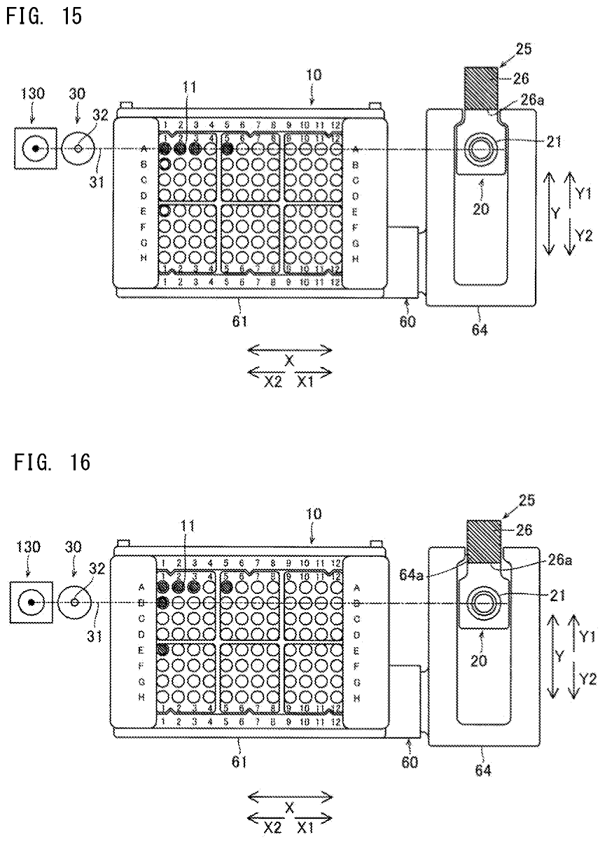

As shown in FIG. 12, the measurement apparatus 100 includes the controller 120, a storage unit 121, and a communication unit 123. In addition, the measurement apparatus 100 includes: the holder sensor 124 which detects a container holder 12 on the first setting base 10; and a container sensor 125 which detects the second storage portion 21 set on the second setting base 20.

The controller 120 performs various processes on the basis of a program stored in the storage unit 121. The controller 120 performs operation control of the dispenser 30 and the drive unit 50. On the basis of an output signal from an encoder provided to the drive unit 50, the controller 120 obtains and controls the positions of the first setting base 10 and the second setting base 20 in the first direction Y1 and the opposite direction Y2. On the basis of an output signal from an encoder provided to the dispenser 30, the controller 120 obtains and controls the positions of the nozzle 32 in the second direction λ1 and the opposite direction λ2. The controller 120 controls suctioning/discharging operation of the dispenser 30, supplying operation of a sheath liquid to the measurement unit 40, washing operation on components of the fluid circuit unit 110 and the washing port 130, and the like, which are performed by the fluid circuit unit 110. The controller 120 controls measurement operation of the measurement unit 40. The communication unit 123 is communicably connected to a communication unit 330 of the control apparatus 300. The communication unit 123 includes a communication interface and performs information communication in a wired or wireless manner. The controller 120 transmits data of fluorescence images obtained by the measurement unit 40 to the control apparatus 300 via the communication unit 123.

As shown in FIG. 5, the holder sensor 124 is an optical sensor in which the optical axis between a light transmitter and a light receiver is provided so as to extend across the first setting base 10 in the second direction λ1 and the opposite direction λ2. The holder sensor 124 is provided, in the Y direction, at a holder monitoring position P4 between the setting work position P1 and the movement axis 31 of the dispenser 30. Accordingly, the holder sensor 124 detects each detection piece 15 of the first setting base 10 while the first setting base 10 and the second setting base 20 are moved from the setting work position P1 to positions on the movement axis 31 of the dispenser 30. The controller 120 individually obtains the presence or absence of the six container holders 12 on the first setting base 10, on the basis of the detection result by the holder sensor 124 and a drive amount (i.e., the position of the first setting base 10) of the drive unit 50 at the time point of the detection.

The container sensor 125 is an optical sensor in which the optical axis between a light transmitter and a light receiver is provided so as to extend across the second holding hole 22 of the second setting base 20. As shown in FIG. 5, the container sensor 125 is provided at a position of the second setting base 20 at the setting work position P1. The container sensor 125 detects the second storage portion 21 on the basis of the fact that the second storage portion 21 set in the second holding hole 22 of the second setting base 20 has blocked light of the container sensor 125.

The control apparatus 300 includes a controller 310, a storage unit 320, and the communication unit 330. The controller 310 is implemented by a processor such as a CPU. The storage unit 320 is implemented by a RAM, a ROM, a hard disk, and the like. The communication unit 330 includes a communication interface. The control apparatus 300 is a PC (personal computer) in which the controller 310 performs various processes on the basis of a program stored in the storage unit 320. The control apparatus 300 includes a display unit 340 and an input unit 350. The display unit 340 and the input unit 350 may be connected to the control apparatus 300 from outside, or may be of a built-in type incorporated in the control apparatus 300. The display unit 340 is a display device such as a liquid crystal display or an EL display. The input unit 350 is an input device such as a keyboard, a mouse, or a touch panel. As an example, the control apparatus 300 includes a touch panel-type display in which the display unit 340 and the input unit 350 are integrated.

The controller 310 transmits to the measurement apparatus 100 various types of information such as a start instruction and a stop instruction of measurement operation for the measurement apparatus 100, and measurement information 170 (see FIG. 14) including a setting position of a first storage portion 11 storing a sample to be measured. The controller 310 analyzes a fluorescence image obtained by the measurement unit 40 and generates a measurement result for a measurement item. For example, the controller 310 compares a bright point pattern of a cell in a fluorescence image with a bright point pattern of a reference image obtained in advance, and determines whether the cell is an abnormal cell having a chromosomal abnormality at the target site or the cell is a normal cell not having a chromosomal abnormality at the target site. The controller 310 generates information of an analysis result including one or a plurality among, for example, the number of abnormal cells, the proportion of abnormal cells, the number of normal cells, the proportion of normal cells, and the like, and stores the information in the storage unit 320 in association with the measurement information 170 (see FIG. 7).

<Input of Setting Position>

In the configuration example in FIG. 12, the user can input a setting position of a first storage portion 11 to the control apparatus 300. The input unit 350 of the control apparatus 300 receives an input of a setting position of a first storage portion 11 as an analysis target in the first setting base 10.

When inputting a setting position, a screen 180 (see FIG. 13) showing setting positions of first storage portions 11 in the first setting base 10 is displayed on the display unit 340. The controller 310 causes the display unit 340 to output and display the image of the screen 180. The controller 310 obtains, via the input unit 350, the setting position of the first storage portion 11 on the screen 180 shown in FIG. 13. The controller 310 transmits, to the measurement apparatus 100, measurement information 170 (see FIG. 14) including information 171 of the setting position obtained via the input unit 350.

Accordingly, even in a case where the number of setting positions at which first storage portions 11 are disposed on the first setting base 10 is large, the user can input the setting position of each first storage portion 11 as the measurement target, while visually confirming each setting position on the screen 180. As a result, inputting work of the setting position of each first storage portion 11 can be facilitated, and occurrence of erroneous input can be inhibited.

In the example in FIG. 13, the screen 180 includes a schematic diagram 181 representing arrangement of the first holding holes 13 of the first setting base 10. As shown in FIG. 7, in a case of the first setting base 10 in which the first holding holes 13 are arrayed in 8 rows×12 columns, i.e., Row A to Row H and column 1 to column 12, the schematic diagram 181 includes figures (i.e., icons) 182 which represent first holding holes 13 in 8 rows×12 columns. One FIG. 182 represents one first holding hole 13 at the same position in the first setting base 10.

When the user has set a first storage portion 11 to a first holding hole 13 of the first setting base 10, the user selects and inputs (i.e., touch operation) a FIG. 182 at the same position as that of the first holding hole 13 at which the first storage portion 11 has been set. The controller 310 obtains the position of the first holding hole 13 indicated by the selected and inputted FIG. 182, as the setting position of the first storage portion 11 as the measurement target. At this time, the controller 310 changes the display mode of the selected and inputted FIG. 182 so as to be distinguishable from unselected FIG. 182. The FIG. 182 of which the display mode has been changed represents the first storage portion 11 set in the first holding hole 13 at the same setting position. Accordingly, the setting position of the first storage portion 11 as the measurement target is reflected on the screen 180. In FIG. 13, selected and inputted FIG. 182 are hatched.

The setting position of a first storage portion 11 can be represented by a combination of a row number and a column number, for example. In the example in FIG. 13, the row number is represented by A to H, and the column number is represented by 1 to 12. The representation format of the setting position is assumed as “(row number)-(column number)” (see FIG. 14).

For example, in FIG. 7, the first storage portions 11 are set to the first holding holes 13 at six positions of A-1, A-2, A-3, A-5, B-1, and E-1 of the first setting base 10. When the user selects and inputs FIG. 182 at corresponding positions on the screen 180, a display indicating that the FIG. 182 at the six positions of A-1, A-2, A-3, A-5, B-1, and E-1 are the setting positions of the first storage portions 11 as the measurement targets is shown on the screen 180 in FIG. 13. In this manner, information 171 (see FIG. 14) of the setting positions of the first storage portions 11 as the measurement targets is obtained.

As shown in FIG. 14, in addition to the information 171 of the setting positions of the first storage portions 11 as the measurement targets, the controller 310 obtains, one by one via the input unit 350, specimen information 172 representing a specimen stored in each first storage portion 11, measurement item information 173 representing a measurement item for the specimen, and the like, for example. The controller 310 stores, in the storage unit 320, these pieces of information in association with the information 171 of the setting positions. Then, at the start of measurement, the controller 310 causes each piece of the obtained information as the measurement information 170 to be transmitted to the measurement apparatus 100. When an analysis result has been obtained, the controller 310 additionally stores the analysis result in association with the measurement information 170 in the storage unit 320.

<Movement of Setting Base>

Next, with reference to FIG. 5 and FIG. 15 to FIG. 18 mainly, movement of the setting bases during measurement is described. The first setting base 10 and the second setting base 20 are disposed at the setting work position P1 (see FIG. 5) as the initial position before the start of measurement. That is, the drive unit 50 is configured to position the first setting base 10 and the second setting base 20 at the setting work position P1 which is away from the movement axis 31 of the dispenser 30 in the first direction Y1.

The drive unit 50 is configured to, when the measurement is started, move the first setting base 10 having set thereon a plurality of first storage portions 11 and the second setting base 20 having set thereon the second storage portion 21, in the first direction Y1 from the setting work position P1 toward the movement axis 31 of the dispenser 30.

Accordingly, the work of setting a plurality of first storage portions 11 to the first setting base 10 and the work of setting the second storage portion 21 to the second setting base 20, which are performed by the user, can be performed at the setting work position P1 away from the movement axis 31 of the dispenser 30. Therefore, the movement mechanism and the like of the dispenser 30 does not obstruct the setting work, and the setting work can be efficiently performed.

During the measurement, the controller 120 of the measurement apparatus 100 controls the drive unit 50 on the basis of the information 171 of the setting positions of the first storage portions 11 as the measurement targets.

The controller 120 positions (see FIG. 15) one first storage portion 11 set on the first setting base 10, at a position on the movement axis 31 of the dispenser 30, and controls the drive unit 50 and the dispenser 30 such that the dispenser 30 suctions the liquid in the second storage portion 21 on the second setting base 20 and dispenses the liquid into the first storage portion 11 on the first setting base 10. Then, the controller 120 positions (see FIG. 16) another first storage portion 11 set on the first setting base 10, at a position on the movement axis 31 of the dispenser 30, and controls the drive unit 50 and the dispenser 30 such that the dispenser 30 suctions the liquid in the second storage portion 21 on the second setting base 20 and dispenses the liquid into the first storage portion 11 on the first setting base 10. Accordingly, the plurality of first storage portions 11 set on the first setting base 10 can be subjected, one by one in order, to dispensing operation and then measurement by the measurement unit 40 in the dispensed order.

More specifically, the controller 120 controls the drive unit 50 so as to position a plurality of first storage portions 11 set on the first setting base 10, to positions on the movement axis 31 of the dispenser 30, from the first storage portions 11 at the head in the first direction Y1 in order. Accordingly, simply by the first setting base 10 and the second setting base 20 being moved by the drive unit 50 in one direction, i.e., in the first direction Y1, dispensing work to the plurality of first storage portions 11 set in the first direction Y1 on the first setting base 10 can be completed. Therefore, operation of the drive unit 50 of moving the first setting base 10 and the second setting base 20 can be simplified.

The drive unit 50 moves the first setting base 10 and the holding body 60 in the first direction Y1, thereby moving the second setting base 20 held by the holding body 60 in the first direction Y1, and moves the first setting base 10 and the holding body 60 in the first direction Y1 while the second setting base 20 is caused to remain stopped in a state where the second setting base 20 is in contact with the movement stopping unit 25 (i.e., the stopper 26). Accordingly, while the second setting base 20 remains positioned on the movement axis 31, dispensing operation to a plurality of first storage portions 11 can be sequentially performed.

The controller 120 of the measurement apparatus 100 controls the dispenser 30 and the drive unit 50 such that dispensing operation is performed for the first storage portions 11 set at the setting positions obtained via the input unit 350, and dispensing operation is not performed for first storage portions 11 at setting positions other than the setting positions obtained via the input unit 350. Accordingly, it is possible to skip the operation of moving, among a plurality of setting positions at which a plurality of first storage portions 11 are disposed in the first setting base 10, the setting positions other than the setting positions as the measurement targets, to dispensing positions on the movement axis 31 of the dispenser 30. That is, operation of the drive unit 50 can be further simplified because the dispensing operation is completed simply by moving only the setting positions of the first storage portions 11 as the measurement targets to dispensing positions on the movement axis 31.

Here, for convenience, an example case where six positions of A-1, A-2, A-3, A-5, B-1, and E-1 as in FIG. 13 are the setting positions as the measurement targets is described. In this case, the controller 120 of the measurement apparatus 100 causes dispensing operation and measurement operation to be performed for the first storage portions 11 at the six positions of A-1, A-2, A-3, A-5, B-1, and E-1, and does not cause dispensing operation and measurement operation to be performed for the positions other than the six positions. Even when another first storage portion 11 is set at a position different from the obtained six setting positions as the measurement targets, the controller 120 does not cause dispensing operation and measurement operation to be performed for the first storage portion 11. In FIG. 15 to FIG. 18, the first storage portions 11 as the measurement targets are hatched. The user need not set first storage portions 11 in order without leaving vacancy from the first holding holes 13 positioned on the head side (Row A), and can set first storage portions 11 at desired positions. Therefore, for example, a plurality of specimen groups handled by the user can be classified and set in container holders 12, respectively, and thus, usability is improved.

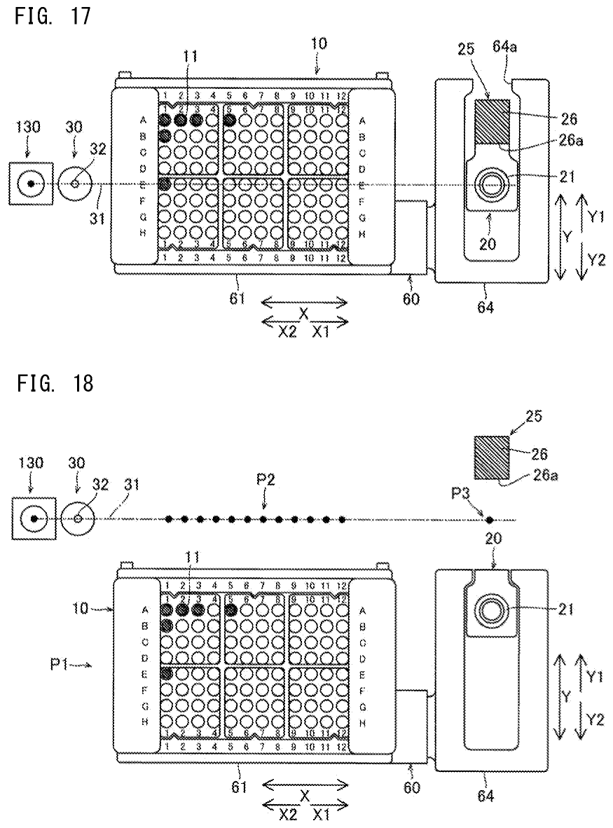

As shown in FIG. 15, the controller 120 causes the first storage portions 11 in Row A to be disposed on the movement axis 31, first, and then, causes dispensing operation and measurement operation to be performed for each first storage portion 11 at A-1, A-2, A-3, and A-5. Next, as shown in FIG. 16, the controller 120 causes the first storage portion 11 in Row B to be disposed on the movement axis 31, and then causes dispensing operation and measurement operation to be performed for the first storage portion 11 at B-1. Next, as shown in FIG. 17, the controller 120 causes the first storage portion 11 in Row E to be disposed on the movement axis 31, and then, causes dispensing operation and measurement operation to be performed for the first storage portion 11 at E-1. In this manner, with respect to a row having no setting position as the measurement target among rows A to H, the controller 120 performs control such that the process of stopping said row on the movement axis 31 is skipped and said row is caused to pass the movement axis 31 without being stopped.

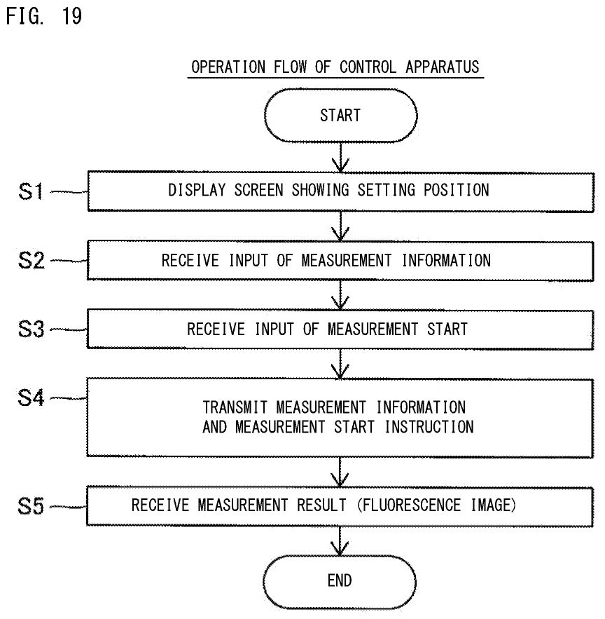

When the measurement ends, as shown in FIG. 18, the first setting base 10 and the second setting base 20 are returned to the setting work position P1, which is the initial position. That is, the drive unit 50 is configured to move the first setting base 10 and the second setting base 20 which have been moved toward the dispenser 30, to the setting work position P1. When being moved to the setting work position P1 by the drive unit 50, the second setting base 20 is separated from the stopper 26 to be moved to the setting work position P1.

Accordingly, the user can perform collecting work of the first storage portions 11 and the second storage portion 21 having been subjected to the measurement and the next setting work of storage portions, at the setting work position P1 which is the same place where the setting work of the first storage portions 11 and the second storage portion 21 is performed. Therefore, the measurement apparatus 100 can be downsized, and convenience for the user can be improved. In addition, the drive unit 50 can move both of the first storage portions 11 and the second storage portion 21 to the setting work position P1 simply by moving, in the Y2 direction, the first setting base 10 and the second setting base 20 of which movement has been stopped by the stopper 26. That is, it is not necessary to provide movement mechanisms separately for the first setting base 10 and the second setting base 20, and thus, the structure and operation of the drive unit 50 can be simplified. FIG. 18 schematically shows that each setting base has been returned to the setting work position P1. In FIG. 18, the distance between the setting work position P1 and the movement axis 31 in the Y2 direction, and the like are different from those in FIG. 5.

(Description of Measurement Process Operation)

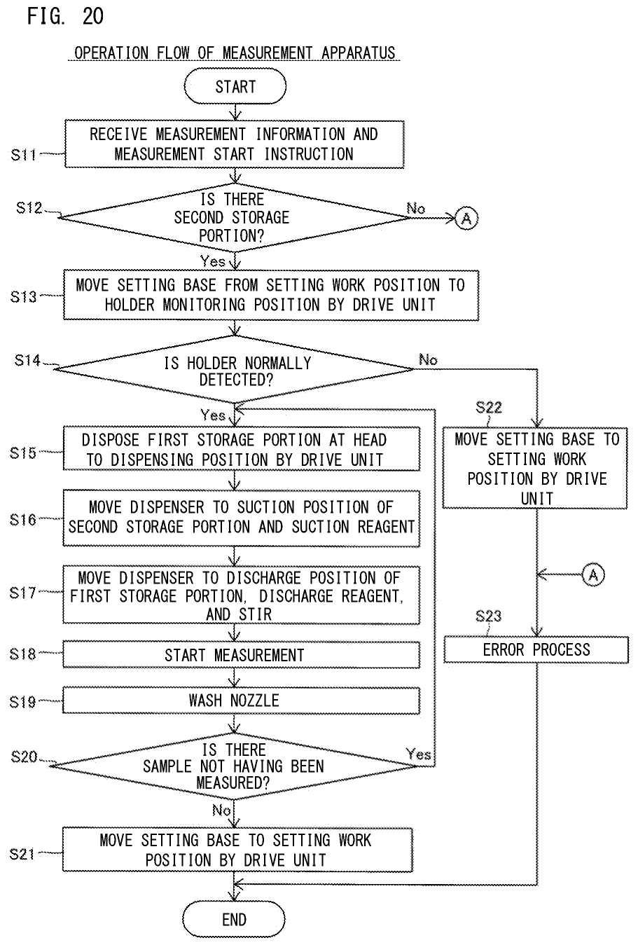

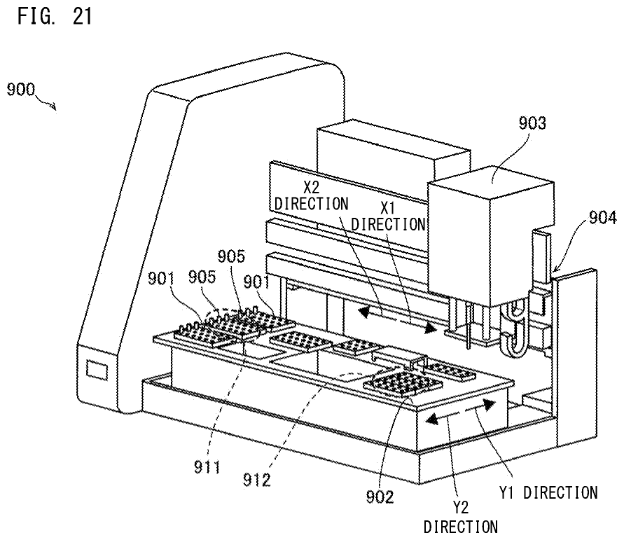

Next, the measurement process operation of the measurement apparatus 100 shown in FIG. 5 is described with reference to FIG. 19 and FIG. 20. The process of each step shown in FIG. 19 is controlled by the controller 310 of the control apparatus 300. The process of each step shown in FIG. 20 is controlled by the controller 120 of the measurement apparatus 100.

As preparation work before the flow below, the user sets first storage portions 11 to the first setting base 10 of the measurement apparatus 100 and sets the second storage portion 21 to the second setting base 20. Before the start of measurement, the first setting base 10 and the second setting base 20 are disposed at the setting work position P1 by the drive unit 50. A first liquid 71 being a pretreated sample is stored in advance in each first storage portion 11. The user sets, one by one, the first storage portions 11 to first holding holes 13 of the first setting base 10, by the number of the first liquids 71 (i.e., first storage portions 11) to be measured. The second liquid 72 being a liquid reagent containing beads is stored in advance in the second storage portion 21.

First, operation of the control apparatus 300 is described. In step S1 in FIG. 19, the screen 180 (see FIG. 13) indicating setting positions of first storage portions 11 is displayed. The controller 310 causes the display unit 340 to display the screen 180 stored in the storage unit 320. On the screen 180, each FIG. 182 indicating a first holding hole 13 is in an unselected state.

In step S2, the controller 310 receives an input of the measurement information 170 (see FIG. 14). Specifically, the controller 310 receives an input of setting positions of first storage portions 11 as the measurement targets, on the basis of the selection and input of FIG. 182 on the screen 180 in FIG. 13. The controller 310 changes the display mode of each selected and inputted FIG. 182, and stores information 171 of the selected and inputted setting positions in the storage unit 320. For each selected and inputted first storage portion 11, the controller 310 receives an input of specimen information 172 and measurement item information 173. The controller 310 stores the received measurement information 170 into the storage unit 320.

In step S3, the controller 310 receives an input operation of measurement start via the input unit 350 by the user. Upon reception of the input operation of measurement start, the controller 310 transmits, in step S4, the measurement information 170 obtained in step S2 and a measurement start instruction to the measurement apparatus 100 via the communication unit 330. On the basis of the measurement start instruction, measurement operation of the measurement apparatus 100 shown in FIG. 20 is started.

In step S5, the controller 310 receives fluorescence images from the measurement apparatus 100 via the communication unit 330. On the basis of the received fluorescence image, the controller 310 performs analysis for each sample (for each piece of specimen information 172) stored in each first storage portion 11.

Next, operation of the measurement apparatus 100 is described.

In step S11 in FIG. 20, the controller 120 receives the measurement information 170 and the measurement start instruction from the control apparatus 300 via the communication unit 123 (see step S4). Accordingly, the controller 120 obtains setting positions of the first storage portions 11 as the measurement targets.

In step S12, the controller 120 determines whether or not the second storage portion 21 is set on the second setting base 20. The controller 120 determines the presence or absence of the second storage portion 21 on the basis of an output signal of the container sensor 125 disposed at a side position of the second setting base 20 at the setting work position P1. When the second storage portion 21 is not detected, the controller 120 performs an error process of step S23 described later.

When the second storage portion 21 has been detected, the controller 120 causes, in step S13, the drive unit 50 to move the holding body 60 (the first setting base 10 and the second setting base 20) in the first direction Y1. At this time, the controller 120 causes the first setting base 10 to be moved to the holder monitoring position P4 (see FIG. 5) for the holder sensor 124.

In step S14, the controller 120 determines whether or not a container holder 12 has been normally detected by the holder sensor 124. The controller 120 determines it to be normal when, for example, all of six container holders 12 that can be set in the recess 14 have been detected. In order to complete the measurement, it is sufficient that at least each container holder 12 that includes the setting positions of the first storage portions 11 as the measurement targets is set on the first setting base 10. For example, in a case where measurement is performed for the first storage portions 11 at six positions of A-1, A-2, A-3, A-5, B-1, and E-1 as shown in FIG. 7, it is sufficient that three container holders 12 that include these setting positions are set. Therefore, the controller 120 may determine it to be normal when the corresponding three container holders 12 have been detected.

When the container holder 12 is not detected normally, the controller 120 causes, in step S22, the drive unit 50 to return the holding body 60 to the setting work position P1. Then, in step S23, the controller 120 performs a predetermined error process. For example, the controller 120 transmits an error signal and the content of the error to the control apparatus 300, thereby causing the display unit 340 to display a screen including a message indicating the content of the error.

When the container holder 12 has been normally detected, the controller 120 causes, in step S15, the drive unit 50 to dispose first storage portions 11 at the head in the first direction Y1 onto dispensing positions on the movement axis 31 of the dispenser 30. In the example shown in FIG. 13, the controller 120 sets the positions of the first holding holes 13 in Row A on the movement axis 31 (see FIG. 15). Different from FIG. 13, in a case where no first storage portion 11 in Row A is included in the measurement target, first storage portions 11 set in a row that is closest to the movement axis 31 side (Y1 direction side) of the dispenser 30 among the first storage portions 11 as the measurement targets are the first storage portions 11 at the head. For example, when there is no measurement target in Row A and Row B, and there is a first storage portion 11 as the measurement target in Row C, Row C is the head.

As shown in FIG. 15, at the time point when the first holding holes 13 in Row A are positioned on the movement axis 31 of the dispenser 30, the second setting base 20 contacts the stopper 26 and movement in the Y1 direction is stopped. Therefore, in a state where first holding holes 13 in any row of the first setting base 10 are disposed on the movement axis 31, the dispenser 30 can suction the reagent from the second storage portion 21.

In step S16, the controller 120 causes the dispenser 30 to be moved to the suction position P3 of the second storage portion 21, and causes the dispenser 30 to suction the second liquid 72. Specifically, under control of the controller 120, the dispenser 30 (see FIG. 6) moves the nozzle 32 to the suction position P3 which is a position immediately above the second storage portion 21 on the movement axis 31. At the suction position P3, the dispenser 30 moves the nozzle 32 downwardly to enter the inside of the second storage portion 21. The controller 120 causes, by means of the fluid circuit unit 110, the second liquid 72 in the second storage portion 21 to be suctioned through the nozzle 32. After the suction, at the suction position P3, the dispenser 30 moves the nozzle 32 upwardly to move the nozzle 32 immediately above, on the outside of, the second storage portion 21.

In step S17, the controller 120 causes the dispenser 30 to move to a discharge position P2 of a first storage portion 11, and causes the dispenser 30 to discharge the suctioned second liquid 72 and perform stirring operation. In the configuration example shown in FIG. 5, there are 12 discharge positions P2 (column 1 to column 12) on the movement axis 31. Under control of the controller 120, the dispenser 30 moves the nozzle 32 to a discharge position P2 which is a position immediately above the first storage portion 11 as the measurement target, and causes the second liquid 72 to be discharged from the nozzle 32 into the first storage portion 11. After the discharge, the controller 120 performs, by means of the fluid circuit unit 110, suction of the liquid in the first storage portion 11 and discharge of the suctioned liquid into the first storage portion 11 one or a plurality of times. As a result of the suction and the discharge, the first liquid 71 and the second liquid 72 are stirred in the first storage portion 11.

In step S18, the controller 120 causes measurement operation on the measurement sample 73 (see FIG. 11) in the first storage portion 11 having dispensed therein the second liquid 72, to be started. The controller 120 causes, by means of the fluid circuit unit 110, the measurement sample 73 stirred in the first storage portion 11 to be suctioned from the nozzle 32. The controller 120 controls the fluid circuit unit 110 such that the measurement sample 73 taken into the nozzle 32 is sent to the flow cell 150 of the measurement unit 40 via the flow path. The controller 120 controls the fluid circuit unit 110 such that a sheath liquid is sent to the flow cell 150. Accordingly, a sheath flow containing labeled cells and beads is formed in the flow cell 150.

The controller 120 causes lights from the light sources 151 to 154 to be applied to the flow cell 150, and causes the imaging section 165 to capture images of generated fluorescences and scattered light. Then, the controller 120 calculates speed information 166 from the result of captured images of beads, and performs feed-back control of imaging process of the imaging section 165. Acquisition of the speed information 166 and the feed-back control are continuously performed while the measurement sample 73 is sent. Upon completion of the sending of the measurement sample 73, the measurement operation on the sample ends.

In step S19, after the measurement operation has ended, the controller 120 causes washing operation of the nozzle to be performed. First, the controller 120 causes the nozzle 32 (see FIG. 6) to move to the origin position, which is a position immediately above the washing port 130. Then, the controller 120 causes the outer surface of the nozzle 32 to be washed inside the washing port 130. Further, the controller 120 causes the fluid circuit unit 110 to send the sheath liquid to the flow channel of the mixture, to wash the flow channel. The flow channel of the mixture includes the flow cell 150, the flow path, and the nozzle 32. Liquids such as the mixture subjected to the measurement operation, and the liquid subjected to the washing operation are discharged into a waste liquid chamber included in the fluid circuit unit 110.

Through the above operation, measurement operation on a sample (the first sample) stored in the first storage portion 11 at the first order ends. When fluorescence images have been obtained by the measurement unit 40, the controller 120 transmits data of the fluorescence images to the control apparatus 300 via the communication unit 123. The controller 120 sets, as a measured position, the setting position (e.g., A-1) of the first storage portion 11 for which the measurement has been completed.

In step S20, with reference to the measurement information 170, the controller 120 determines whether or not there is a setting position for which measurement has not been performed. When there is a setting position for which measurement has not been performed, the controller 120 returns the process to step S15.

At this time, when there is a setting position (e.g., A-2) of another first storage portion 11 as the measurement target in the same row (Row A) as that of the setting position (e.g., A-1) of the first storage portion 11 measured in the previous time, the first setting base 10 is not moved in step S15. Then, in steps S16 to S19, suctioning and discharging of the second liquid 72, the measurement operation, and the washing operation of the nozzle 32 are performed for the first storage portion 11 at the next setting position. In the example shown in FIG. 13, steps S16 to S19 are sequentially performed for each first storage portion 11 set in A-1, A-2, A-3, and A-5. As a result, in the head Row A, all setting positions as the measurement targets become measured positions. Therefore, in FIG. 13, the next head row after Row A is Row B.

When there is no setting position of another first storage portion 11 as the measurement target in the same row, the first holding holes 13 in Row B, which becomes the head row next are positioned at dispensing positions on the movement axis 31 of the dispenser 30 in step S15 (see FIG. 16). Then, in steps S16 to S19, suctioning and discharging of the second liquid 72, the measurement operation, and the washing operation of the nozzle 32 are performed for the first storage portion 11 at the next setting position (B-1).

The controller 120 performs the measurement operation, for each row in order, from the row that becomes the head row. In the example in FIG. 13, when the measurement operation for the first storage portion 11 at B-1 has ended, the controller 120 controls the drive unit 50 such that Row C and Row D are skipped and the first holding holes 13 in Row E are positioned at dispensing positions (see FIG. 17). Then, in steps S16 to S19, suctioning and discharging of the second liquid 72, the measurement operation, and the washing operation of the nozzle 32 are performed for the first storage portion 11 at the next setting position (E-1).

When the controller 120 has determined, in step S20, that there is no sample for which the measurement has not been performed, the controller 120 causes the measurement process to be completed, and advances to step S21. In step S21, the controller 120 controls the drive unit 50 such that the first setting base 10 and the second setting base 20 are returned to the setting work position P1 (see FIG. 18).

Then, the operation of the measurement apparatus 100 is completed.

In the flow described above, when a plurality of first storage portions 11 as the measurement targets are set in the same row (e.g., Row A in FIG. 13), the second liquid 72 may be suctioned from the second storage portion 21 by an amount corresponding to the number of first storage portions 11 as the measurement targets, and only the discharging operation except the stirring may be performed for each of the first storage portions 11 as the measurement targets. That is, the operation of step S16 to the operation of discharging the second liquid 72 in step S17 may be performed for the plurality of first storage portions 11, first, and then the stirring operation in step S17 to the operations of steps S18 and S19 may be performed for the first storage portions 11, one by one, in order.

It should be noted that the embodiment disclosed herein is merely illustrative in all aspects and should not be considered as being restrictive. The scope of the present disclosure is not defined by the description of the above embodiment but by the scope of the claims, and further includes meaning equivalent to the scope of the claims and all modifications within the scope of the claims.

What is claimed is:

1. A measurement apparatus comprising:
a first setting base capable of having set thereon a plurality of first storage portions arranged in a first direction, each of the plurality of first storage portions storing a liquid;
a second setting base capable of having set thereon a second storage portion storing a liquid different from the liquid stored in each of the plurality of first storage portions, the second setting base being disposed in a second direction crossing the first direction with respect to the first setting base;
a holding body configured to hold the first setting base and to hold the second setting base so as to be movable relative to the first setting base;
a drive unit configured to move the holding body in the first direction;
a dispenser configured to move along a movement axis thereof in the second direction, to suction the liquid in the second storage portion on the second setting base and dispense the liquid into each first storage portion on the first setting base;
a measurement unit configured to measure a mixture dispensed in the first storage portion by the dispenser; and
a movement stopping unit configured to, when the holding body has been moved in the first direction by the drive unit, stop movement in the first direction of the second setting base while the first setting base is still allowed to be moved in the first direction.

2. The measurement apparatus of claim 1, wherein
the movement stopping unit includes a stopper provided at a position at which the stopper contacts the second setting base in a state where a first storage portion at a head in the first direction among the plurality of first storage portions and the second storage portion are disposed on the movement axis of the dispenser.

3. The measurement apparatus of claim 1, wherein
the drive unit is configured to
position the first setting base and the second setting base at a setting work position which is away from the movement axis of the dispenser in the first direction, and
move the first setting base having set thereon the plurality of first storage portions and the second setting base having set thereon the second storage portion, in the first direction from the setting work position toward the movement axis of the dispenser.

4. The measurement apparatus of claim 3, further comprising
a separation wall which provides separation between the setting work position and the dispenser, wherein
the first setting base and the second setting base are provided so as to pass the separation wall.

5. The measurement apparatus of claim 3, wherein
the drive unit is configured to move the first setting base and the second setting base which have been moved toward the movement axis of the dispenser, to the setting work position, and
when being moved by the drive unit to the setting work position, the second setting base is separated from the movement stopping unit to be moved to the setting work position.

6. The measurement apparatus of claim 3, wherein
the holding body is configured to hold the second setting base so as to allow relative movement thereof in a direction opposite to the first direction, and is configured to move integrally with the first setting base, and
the drive unit moves the first setting base and the holding body in the first direction, thereby moving, in the first direction, the second setting base held by holding body, and moves the first setting base and the holding body in the first direction while the second setting base is caused to remain stopped in a state where the second setting base is in contact with the movement stopping unit.

7. The measurement apparatus of claim 6, wherein
the holding body includes a biasing member configured to bias the second setting base in the first direction toward the movement axis of the dispenser, and
by being positioned, by the biasing member, to an end portion on the first direction side in a movement range in the holding body thereby contacting the movement stopping unit, the second setting base moves to a side opposite to the first direction relative to the holding body which moves in the first direction while compressing the biasing member.

8. The measurement apparatus of claim 6, wherein
the holding body includes a frame-shaped portion surrounding the second setting base and holds the second setting base on an inner side of the frame-shaped portion so as to allow relative movement of the second setting base in the direction opposite to the first direction, and
the second setting base is provided so as to be movable, on the inner side of the frame-shaped portion, in the first direction within a range between a first storage portion at a head in the first direction and a first storage portion at an end in the first direction on the first setting base.

9. The measurement apparatus of claim 1, further comprising
a controller programmed to control operations of the drive unit and the dispenser, wherein
the controller controls the drive unit such that the plurality of first storage portions set on the first setting base are positioned at a position on the movement axis of the dispenser, from a first storage portion at a head in the first direction in order.

10. The measurement apparatus of claim 9, further comprising
an input unit configured to receive an input of a setting position, in the first setting base, of a first storage portion as an analysis target, wherein
the controller controls the dispenser and the drive unit such that dispensing operation is performed for the first storage portion set at the setting position obtained via the input unit, and dispensing operation is not performed for a first storage portion at a setting position other than the setting position obtained via the input unit.

11. The measurement apparatus of claim 10, further comprising
a display unit configured to display a position displaying screen indicating the setting position of the first storage portion in the first setting base, wherein
the controller obtains the setting position of the first storage portion via the input unit on the position displaying screen.

12. The measurement apparatus of claim 1, further comprising
a washing port provided at a position on the movement axis of the dispenser, the washing port being for washing the dispenser.

13. The measurement apparatus of claim 1, wherein
the first setting base is configured to be able to have disposed thereon the plurality of first storage portions arranged along the first direction and the second direction.

14. The measurement apparatus of claim 1, wherein
the first storage portion is a tubular sample container capable of storing a specimen, and
the first setting base includes a plurality of first holding holes capable of holding, one by one, a plurality of the first storage portions.

15. The measurement apparatus of claim 1, wherein
the second storage portion is a tubular reagent container capable of storing a liquid, and
the second setting base includes one second holding hole capable of holding the single second storage portion.

16. The measurement apparatus of claim 15, wherein
the first setting base includes a plurality of first holding holes capable of holding, one by one, a plurality of the first storage portions, and
an inner diameter of the second holding hole is greater than an inner diameter of each of the first holding holes.

17. The measurement apparatus of claim 1, wherein
the first storage portion is a tubular sample container capable of storing a specimen,
the second storage portion is a tubular reagent container capable of storing beads, and
the measurement unit is configured to measure a particle in the specimen contained in the mixture on the basis of a measurement result of each bead contained in the mixture.

18. The measurement apparatus of claim 1, wherein
the movement stopping unit includes a magnetic member configured to fix the second setting base in a state where a first storage portion at a head in the first direction among the plurality of first storage portions and the second storage portion are disposed on the movement axis of the dispenser.
